(19) United States
(12) Patent Application Publication
(10) Pub. No.: US 2010/0042553 A1
(43) Pub. Date: Feb. 18, 2010

(54) ASSET ANALYSIS ACCORDING TO THE REQUIRED YIELD METHOD

(76) Inventor: Julian Van Erlach, Clifton Park, NY (US)

Correspondence Address: SCHMEISER, OLSEN & WATTS, 22 CENTURY HILL DRIVE, SUITE 302, LATHAM, NY, 12110, US

(21) Appl. No.: 12/542,075

(22) Filed: Aug. 17, 2009

Related U.S. Application Data
(60) Provisional application No. 61/089,619, filed on Aug. 18, 2008.

(51) Int. Cl. G06Q 40/00

(52) U.S. Cl. 705/36 R; 705/37

(57) ABSTRACT

A method and system for performing an asset analysis. At least one asset characteristic is computed. The at least one asset characteristic consists of at least one of: a new or expected currency exchange rate between two countries, a world gold price, a national gold price of a country, an expected or next period earnings per share (EPS) of a stock index, a current price of a stock index or stock, a consol-type yield of a consol-type instrument traded within a world or national economy characterized by a commodity standard, a yield spread between a long and short term Treasury bond, a dividend yield of a stock index or stock, a bond price of a bond, an expected gross domestic product (GDP) of an economy. The computed at least one asset characteristic is transferred to a tangible medium and utilized.

### COPYRIGHT AND TRADEMARK STATEMENT

This patent document claims the benefit of all copyright laws and is deemed as copyrighted. Trademarks have been granted for “RYT” and “Required Yield Theory” and are owned by the applicant. All rights are reserved.

### FIELD OF THE INVENTION

The present invention relates to a method, computer system, and computer program product for asset analysis, including securities and commodities and asset valuation and applications thereof, and further including investment portfolio analysis and asset management.

### BACKGROUND OF THE INVENTION

Current asset valuation methods and systems do not provide a close link in either theoretical or empirical terms between macro economics and a related articulated method of valuing diverse assets classes such as stocks, bonds, gold and exchange rates. There is a need for a theoretically grounded methodology that also provides high explanatory power of actual asset prices as related to macro-economic attributes compared to what exists in the related art.

### SUMMARY OF THE INVENTION

The present invention provides a method for performing an asset analysis, said method comprising:

computing, by a processor of a computer system, at least one asset characteristic of at least one asset or of a plurality of asset classes, said at least one asset characteristic selected from the group consisting of a first asset characteristic, a second asset characteristic, a third asset characteristic, a fourth asset characteristic, a fifth asset characteristic, a sixth asset characteristic, a seventh asset characteristic, an eighth asset characteristic, a ninth asset characteristic, a tenth asset characteristic, and combinations thereof;

transferring the computed at least one asset characteristic to a tangible medium selected from the group consisting of an information viewing medium, a printing device, a data storage medium, and combinations thereof;
utilizing one or more computed asset characteristics of the computed least one asset characteristic, said utilizing comprising performing at least one function selected from the group consisting of asset valuation, asset management, trading, portfolio management, portfolio analysis, portfolio construction, asset allocation, risk assessment and/or management, making a recommendation for investment and/or trading, client account support and management, hedging, formulation of investment objectives, running an analytic module comprising assessing a portfolio having the at least one asset therein, running a construction module comprising performing at least one risk and/or economic scenario and generating results therefrom, and combinations thereof;

wherein the first asset characteristic comprises a new or expected currency exchange rate between a first country (C₁) and a second country (C₂) at time t₁, said computing the at least one asset characteristic comprising computing the new or expected currency exchange rate at time t₁ as a function of C₁^{g+1} and C₂^{g+1}, said C₁^{g+1} being an expected real gross domestic product (GDP) growth rate per capita of the first country for a next time period from time t₀ to time t₁ such that t₀<t₁, said C₂^{g+1} being an expected real GDP growth rate per capita of the second country for the next time period;

wherein the second asset characteristic comprises a world gold price at time t₁, said computing the at least one asset characteristic comprising computing the world gold price at time t₁ as a function of (P_{w}⁺¹/S⁺¹) and (P_{w}⁰/S⁰), said P_{w}⁺¹ being an expected world real GDP at time t₁, said S⁺¹ being an expected total world above ground gold stock at time t₁, said P_{w}⁰ being a world real GDP at time t₀ such that t₀<t₁, said S⁰ being an above ground world gold stock at time t₀;

wherein the third asset characteristic comprises a national gold price of a country at time t₁, said computing the at least one asset characteristic comprising computing the national gold price at time t₁ as a function of W_{g} and C_{g}, said W_{g} being a world expected real per capita GDP growth rate for a next time period from time t₀ to time t₁ such that t₀<t₁, said C_{g} being an expected real per capita GDP growth rate of the country for the next time period;

wherein the fourth asset characteristic comprises an expected or next period earnings per share (EPS) of a stock index with respect to an economy, said computing the at least one asset characteristic comprising computing the expected or next period EPS of the stock index as a function of Y⁺¹/Y⁰, said Y⁰ being a required yield of the economy for a current time period such that the current period precedes a next time period, said Y⁺¹ being a required yield of the economy for the next time period;

wherein the fifth asset characteristic comprises a current price of a stock index or stock with respect to an economy, said computing the at least one asset characteristic comprising computing the current price of the stock index or stock as a function of a weighted difference between the EPS of the stock index or stock in successive periods of time, the EPS in each period exceeding an expected GDP per capita growth rate in each period;

wherein the sixth asset characteristic comprises a consol-type yield of a consol-type instrument traded within a world or national economy characterized by a commodity standard in which a value of the world or national currency depends on a fixed exchange rate between money and gold, said computing the at least one asset characteristic comprising computing the consol-type yield as a function of (Z_{g}⁺¹/G_{w}⁺¹) and (Z_{g}⁰/G_{w}⁰), said Z_{g}⁺¹ being an expected total above ground world gold stock at time t₁, said Z_{g}⁰ being a total above ground world gold stock at time t₀ such that t₀<t₁, said G_{w}⁺¹ being an expected world or national economy real GDP for time t₁, said G_{w}⁰ being a world or national economy real GDP at time t₀;

wherein the seventh asset characteristic comprises a yield spread between a long and short term Treasury bond with respect to an economy, said computing the at least one asset characteristic comprising computing the yield spread as a function of R_{L} and R_{S}, said R_{L} being an expected long term real after-tax return on stock market equity subject to R_{L} not exceeding Y_{P}, said R_{S} being an expected short term real after-tax return on stock market equity subject to R_{L} not exceeding Y_{P}, said Y_{P} being a constant after-tax required yield of a financial asset anchored on a GDP productivity growth rate per capita for the economy;

wherein the eighth asset characteristic comprises a dividend yield (D_{Y}) of a stock index or stock with respect to an economy, said computing the at least one asset characteristic comprising computing D_{Y} via D_{Y}=Y−E₁, said Y being an after-tax required yield for the economy, said E₁ being an expected long term growth rate of the EPS of the stock index or stock, said E₁ being less than (g+i), said g being an expected GDP growth rate per capita for the economy, said i being an expected inflation rate for the economy;

wherein the ninth asset characteristic comprises a bond price of a bond at a time t₀, said bond having n remaining consecutive coupon payment periods of time from time t₀ such that a designated coupon amount is required to be paid to a holder of the bond at an end of each remaining coupon payment period, said computing the at least one asset characteristic comprising computing the bond price as a function of i₁, i₂, . . . , iₙ, said iₘ (m=1, 2, . . . , n) being an interest rate/yield of a similarly rated/callable bond having a maturity of m coupon payment periods from time t₀; and

wherein the tenth asset characteristic comprises an expected GDP of an economy, said computing the at least one asset characteristic comprising computing the expected GDP of the economy for a specified time period as a function of a sum of changes over the time period in an expected value of each asset class of a plurality of asset classes with respect to the assets in each asset class.

The present invention provides a computer system, comprising a processing unit and a computer readable memory unit coupled to the processing unit, said memory unit containing instructions configured to be executed by the processing unit to implement the method, said processing unit being said processor.

The present invention provides a computer program product, comprising a computer readable storage medium having a computer readable program code stored therein, said computer readable program code containing instructions configured to be executed by a processing unit to implement the method of claim 1 said processing unit being said processor.

The present invention advantageously provides a methodology for analyzing assets that is grounded in an economic theory that underlies the behavior of assets and exhibits a high degree of predictive and explanatory power compared to what exists in the related art.

### BRIEF DESCRIPTION OF THE DRAWINGS

FIG. 1 is a graph which depicts the actual gold price in USD dollars compared to the price predicted point to point by the Required Yield Method (RYM) in accordance with embodiments of the present invention, shown quarterly based on concurrent data and expectations.

FIG. 2 is a graph which shows that under the gold standard, the world price index was a function of total world gold stock/world real gross domestic product (GDP).

FIG. 3 is a table proving that the observed “Gibson's Paradox” effect is governed by a constant real required yield in terms of yield on nominal price of capital that returns a fixed real basket of goods and services, in accordance with embodiments of the present invention.

FIG. 4 depicts results applying the RYM to the US SP500 1919-1944, in accordance with embodiments of the present invention.

FIG. 5 shows the high correlation and absolute yield level coincidence between the RYT predicted (RYT 30) US 30-year Treasury yield and the actual Treasury Bond Yield 30 (TBY 30), quarterly, 1980-May 2008, in accordance with embodiments of the present invention.

FIGS. 6 and 7 are graphs depicting clear, contemporaneous and proportionate correlations among the economic phenomena with causation driven by the rate and direction of change of earnings per share (EPS).

FIG. 8 depicts the ratio of Baa rated corporate (risky) bonds to like term to maturity treasury bonds compared with real inflation adjusted as reported SP500 earnings per share.

FIG. 9 depicts the coincident relationship, shown quarterly, between the Fed Funds rate, indexed to a beginning time period, and the national return on equity (ROE).

FIG. 10 depicts the quarterly relationship between the risk spread between like term to maturity risky corporate bonds (Baa) to Treasuries, compared with the national return on equity (ROE).

FIG. 11 depicts the quarterly relationship between real US GDP indexed to an initial time period and both real expected next year SP500 earnings per share (EPS), Forward Operating Earnings Expected (FOE) and as reported earnings per share.

FIG. 12 depicts the annual relationship among the Required Yield (RY) as defined herein, the national return on equity (ROE) as defined herein, and the dividend yield of the stock market as computed from Fed Funds Flows data.

FIG. 13 is a block diagram providing an overview of an integrated asset analysis system, in accordance with embodiments of the present invention.

FIG. 14 is a flow chart showing how the RYM may be utilized to analyze a portfolio and rebalance assets therein, in accordance with embodiments of the present invention; based on said portfolio analysis.

FIG. 15 is a flow chart showing how the RYM may be utilized to perform risk assessment and management, in accordance with embodiments of the present invention.

FIG. 16 is a flow chart showing how technical analysis and/or sentiment analysis may be utilized in conjunction with the RYM to determine whether to buy or sell an asset, in accordance with embodiments of the present invention.

FIG. 17 illustrates a computer system used for performing an asset analysis according to the Required Yield Method (RYM), in accordance with embodiments of the present invention.

### DETAILED DESCRIPTION OF THE INVENTION

The Required Yield Method (RYM) based on Required Yield Theory (RYT), which is described in patent application having Ser. No. 10/969,604, filed Oct. 7, 2004 (hereinafter, “Ser. No. 10/969,604”), is incorporated herein in its entirety. The RYM dictates a rate of return from an asset, wherein said rate of return is called a Required Yield (RY or Y).

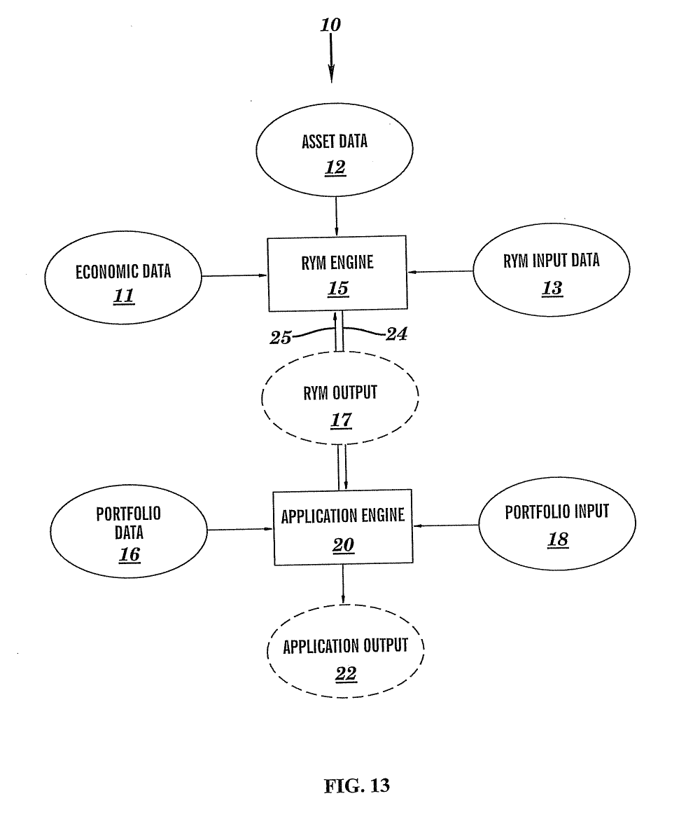

The present invention provides a method and an associated system and computer program product for performing asset analysis according to the RYM. The method provides utilization of economic data relating to one or more economies; computing characteristics of assets (each asset characteristic being a function of a portion of the economic data, the computing being in accordance with the RYM); and transferring the computed characteristics to a tangible medium (e.g., an information viewing medium such as a computer screen, a printer, a data storage unit such as Random Access Memory (RAM), hard disk, optical storage, etc.) for such uses as visual display, hard copy, input to financial analysis software (e.g., the application engine 20 of FIG. 13 discussed infra).

The present detailed description of the invention applies the RYM in a novel and unobvious manner as described in the following sections: 1) exchange rate determination; 2) gold valuation; 3) gold and commodity standard stock valuation and bond yield determination; 4) bond yield curve and short term yield level determination; 5) stock index and individual stock valuation; 6) economic growth impairment forecasting; 7) integrated asset analysis system; 8) portfolio analysis; 9) risk assessment and management; 10) technical and sentiment analysis; 11) computer system.

The Formulas described infra comprise “expected” values of parameters (e.g., in Formula 1, C₁^{g+1} is the first country “expected” real per capita Gross Domestic Product (GDP) growth rate per capita for the next period ). Any such “expected” parameter value may be based on any method of estimating the parameter value that is known or obvious to a person of ordinary skill in the art or as computed or determined by a formula or algorithm described herein. Alternatively, any such “expected” parameter value may be any assumed value, such as may be assumed for the purpose of testing the effect of varying the parameter on the variable being computed by the Formula. For example in Formula 1, any assumed value(s) may be used for C₁^{g+1} to assess the effect on β⁺¹ (as computed by Formula 1) of varying C₁^{g+1}.

For a given reference time t₀ and a next time period (t₁−t₀) such that t₀<t₁, the “required yield” (Y) is generally defined by Formula Y:

Y=(Y_{P}+Ie)/(1−Te) (Y)

wherein Ie is an expected inflation rate over the next time period with respect to an economy, Te is an effective expected investor tax rate over the next time period with respect to the economy, and Y_{P} is a constant after-tax required yield of a financial asset anchored on a GDP productivity growth rate per capita of the economy. The economy may be an economy of an individual country, an economy of group of countries, or the world economy represented as an economy of a representative group of countries whose economies collectively represent the world economy. In one embodiment, Y_{P} is about 2%. The effective expected investor tax rate is the blended effective expected investor tax rate of long term investors in a particular economy (e.g., an economy of a country, a world economy, etc.). The next time period from t₀ to time t₁ is any desired time period (e.g., one month, 6 months, 1 year, 2 years, etc.).

In Formula Y, the required yield Y is a nominal, expected required yield of an investment in the financial asset. Thus, after the expected inflation rate (Ie) over the next time period and the effective expected investor tax rate (Te) over the next time period, Y is an expected real, after-tax return of the financial asset that is based on a long term, real, GDP per capita productivity growth rate of about 2%. An after-tax return of a financial asset is defined as a return of the financial asset after the effect of tax is taken into account. A pre-tax return of a financial asset is defined as a return of the financial asset before the effect of tax is taken into account

It is noted that the long-term average compounded real GDP per-capita growth rate (Y_{P}) for developed countries found by Pritchett (1997) is about 1.5%, which is just lower than the actual U.S. rate of 2.07% (using a 1.33% population/share growth rate) for the period 1926-2001, and the average inflation rate has been 3.15% over the same period. See Prichett, Lant, “Divergence, Big Time”, Journal of Economic Perspectives, 11: 3-17 (Summer 1977). Any other estimate of this growth rate and inflation rate arrived at through historical analysis or other means, can also be applied here.

Unless otherwise stated, “long term” means more than 20 years.

Unless otherwise stated, “short term” means one year or less.

Unless otherwise stated, an economy is an economy of an individual country or an economy of a group of countries such as a world economy comprising representative countries.

Unless otherwise stated, an investor tax rate relating to an asset or asset characteristic is an effective tax rate of the top tax bracket of a representative investor within an economy that taxes the representative investor, and is a weighted or unweighted average of such effective tax rates for the economies of a group of economies such as a world economy comprising representative countries. In one embodiment, the weighted average of such effective tax rates is a GDP-weighted average over the effective rax rates of the economies within the group of economies.

### 1. Exchange Rate Determination

Current exchange rate determination theory focuses on traditional models such as Purchasing Power Parity (PPP) (global commodity price normalization), covered interest rate parity (CIRP), monetary approach, etc. None of these models have been shown to have a high degree of sustained empirical accuracy in explaining or predicting exchange rates. For example, the Real of Brazil appreciated against the United States dollar 2000-2007 while its relative interest rate differential fell, gaining far more than could be explained by the PPP effect of its relative decline in inflation rate vs. the United States dollar. Furthermore, no theory exists that explains why and how entire relative stocks of national assets should be re-priced dramatically because of changes in relative interest rates, real interest rates or inflation expectations.

The RYM of the present invention posits that: (1) an exchange rate change directly implies that the entire relative value of Gross Domestic Product (GDP) flow of one country vs. another, and the asset base of one country vs. another is reassessed dramatically; and (2) relative full expected real GDP per capita as valued by relative national required yields (RYs) determines exchange rates. No one asset class, be it gold, stocks, bonds, or real estate, by itself is of adequate economic mass to account for the relative revaluation of entire relative real GDP flows and the related physical, human and capital assets that determine it.

The RYM of the present invention discloses a Required Yield mechanism of exchange rate determination that accounts for expected relative real GDP per capita growth rates, as well as national valuation of expected real GDP per capita according to the RYT/RYM method, where:

β⁺¹=β⁰×{[(1+C₁^{g+1})/(1+C₂^{g+1})]×(Yc₁₊₁/Y_{C2+1})} (Formula 1A)

In Formula 1A, β⁺¹ is a new or expected currency exchange rate between a first country (C₁) and a second country (C₂) at time t₁; β⁰ is a current exchange rate between the same countries C₁ and C₂ at current time t₀ wherein t₀<t₁; C₁^{g+1} is the first country expected real GDP growth rate per capita for the next time period (i.e., from time t₀ to time t₁); C₂^{g+1} is the second country expected real GDP growth rate per capita for the next time period; Yc₁₊₁ is the first country expected nominal required yield (Y) for the next time period, and Y_{C2+1} is the second country expected nominal required yield (Y) for the next time period. Specifically, β⁺¹ is the number of currency units of the first country that can be exchanged for 1 currency unit of the second country. Yc₁₊₁ and Y_{C2+1} are expressed by Formula 1B and Formula 1C which are embodiments of Formula Y for use with respect to Formula 1A.

Yc₁₊₁=(Y_{P}+Ie₁)/(1−Te₁) (Formula 1B)

Y_{C2+1}=(Y_{P}+Ie₂)/(1−Te₂) (Formula 1C)

wherein Ie₁ and Ie₂ are an expected inflation rate for the next period for country C₁ and country C₂, respectively; Te₁ and Te₂ are an expected effective total applicable tax rate for the next time period to an investor for an asset, asset class, or entire nation as may be in the case of exchange rate determination for country C₁ and country C₂, respectively.

For example with Y_{P}=0.02: at time t₀ two countries C₁ and C₂ have real economies of equal size and equal expectations of inflation rate and real economic growth per capita such that β⁰=1. At time t₁, real growth expectations for country C₁ become 4% from 2% (i.e., C₁^{g+1}=0.04), and inflation rate expectations move from 2% to 4% (i.e., Ie₁=0.04). For country C₂, respective expectations remain unchanged at 2% (i.e., C₂^{g+1}=0.02 and Ie₂=0.02). According to Formula 1A, the new exchange rate (β⁺¹) at time t₁ becomes the time t₀ rate (β⁰) of 1 unit of currency of country C₁ to 1 unit of currency of country C₂ currency or 1×[(1+0.04)/(1+0.02)]×(0.04/0.06)=0.67974 units of currency of country C₁ per unit of currency of country C₂; where the latter expression (0.04/0.06) represents the countries' respective nominal RY's without inclusion of effective national tax rates (Te₁ and Te₂) for simplicity.

### 2. Gold Valuation

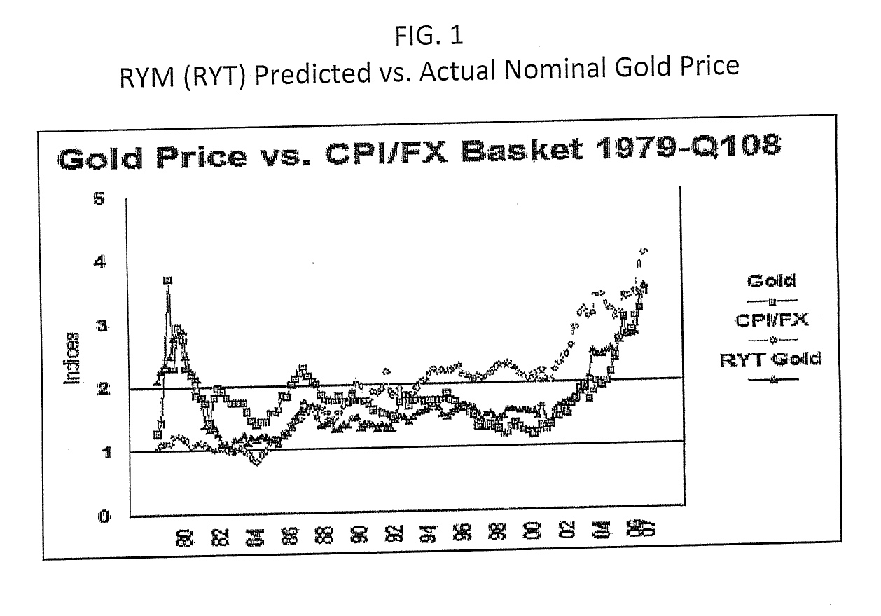

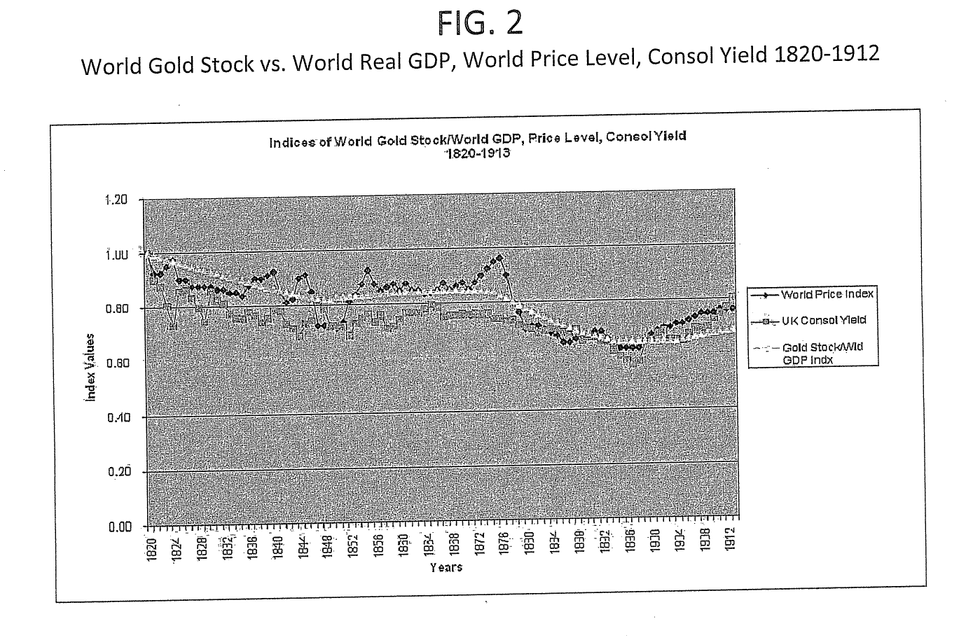

The method of the present invention considers gold to be more than a store of value and considers gold to be a function of a new exchange rate determination mechanism (see Formula 1A above). The long term nominal value of gold Troy oz. is determined by the cumulative rate of change of World nominal GDP/total above ground Troy oz. stock times a given initial price, with its real value being a function of the rate of change of World real GDP/total above ground Troy oz. stock. This is empirically supported in both valuation results in FIG. 1, and by FIG. 2 which shows that under the gold standard, the world price level was a function of total world gold stock/world real GDP.

The local or national value of gold is inextricable from exchange rate influences, which in turn are driven by the mechanisms disclosed herein. The valuation of gold in accordance with the present invention is a novel and unobvious modification of the valuation of gold in Ser. No. 10/969,604 and in published research in the Spring 2005 Jrl. Of Investing, Vol. 14, No. 1 pages 99-111, entitled: “The Price of Gold: A Global Required Yield Theory” by Christophe Faugere and Julian Van Erlach.

RYT and its RYM method results in the graphic relationship of FIG. 1 between the concurrent RYM predicted nominal and actual nominal USD dollar gold price shown quarterly.

The new RYM formula for world gold valuation point to point is:

G⁺¹=[{G⁰×(I⁺¹+((P_{w}⁺¹/S⁺¹)/(P_{w}⁰/S⁰)−1)}+G⁰]×(Y_{w}⁺¹/Y_{w}⁰) (Formula 2)

In Formula 2, G⁺¹ is the world gold price per oz. at time t₁; G₀ is world gold price at earlier time t₀ such that t₀<t₁; I⁺¹ is the expected world inflation rate for the next time period (i.e., from time t₀ to time t₁); P_{w}⁺¹ is world real GDP expected at time t₁, S⁺¹ is expected total world above ground gold stock at time t₁; P_{w}⁰ is world real GDP at time t₀; and S⁰ is above ground world gold stock at time t₀. In one embodiment, the expected world inflation rate is a GDP weighted average inflation rate over a set of representative countries in the world, which may be determined directly or determined from an authoritative source such the International Monetary Fund (IMF) or World Bank. In one embodiment, world real GDP is a weighted or unweighted average GDP over a set of representative countries in the world, which may be determined directly or determined from an authoritative source such the International Monetary Fund (IMF) or World Bank.

Y_{w}⁰ is the world required yield (Y) at time t₀ in accordance with Formula Y, wherein Ie in Formula Y is the expected world inflation rate (I⁺¹) for the next time period from time t₀ to time t₁ such that t₀<t₁, and wherein Te in Formula Y is the world blended effective tax rate for the next time period. Y_{w}⁺¹ is the world required yield (Y) at time t₁ in accordance with Formula Y, wherein Ie in Formula Y is the expected world inflation rate for a subsequent time period from time t₁ to time t₂ such that t₁<t₂, and wherein Te in Formula Y is the world blended effective tax rate for the subsequent time period. Above ground gold stock is defined as the total known estimated supply of mined gold in the world as reported by the World Gold Council or as determined or estimated in any other manner known to a person of ordinary skill in the art. A world blended effective tax rate is a weighted average of applicable tax rates for each country of a set of representative countries, wherein the weights in one embodiment may be proportional to the magnitude of the national asset values of each country.

For example: at time t₀ world gold price is $100/Troy oz. At time t₁ expectations are for world inflation to be 3% as compared to 2% at time t₀ and for world real GDP per gold oz. to grow 3% (which is the rate of change in expression ((P_{w}⁺¹/S⁺¹)/(P_{w}⁰/S⁰)−1) in Formula 2. The resulting gold price would be: [($100×(3%+3%))+$100]×(5%/4%)=$132.50. Note that the last expression is for the world Y assuming no taxation for simplicity.

FIG. 1 is a graph which depicts the actual gold price in USD dollars compared to the price predicted point to point by the Required Yield Method (RYM) in accordance with embodiments of the present invention, shown quarterly based on concurrent data and expectations. In FIG. 1, “RYT Gold” is calculated from Formula 2. CPI/FX is a ratio of Consumer Price Index (CPI) to FX where “FX” is the US dollar equally weighted exchange rate against a basket of currencies comprised of the Canadian dollar, Japanese Yen, Euro, and UK Pound.

FIG. 2 is a graph which shows that under the gold standard, the world price index was a function of total world gold stock/world real GDP.

Gold valuation in a fiat monetary system may further be described as the relationship between two perpetuities: the first paying a cash interest and the second an oz. of gold. Assume gold oz. per capita is constant and there is no taxation of investment returns. When real productivity growth is 2% per capita with no expected inflation, a cash perpetuity paying $2 is valued at $2/2% (RY)=$100. A gold perpetuity paying an oz. of gold where said oz. is initially (i.e., at time t₀) valued at $2 will also be valued at $100. However, at time t₁, (e.g., next year), the gold oz. will be worth 2% more, having gained real per capita productivity growth as its yield, so its perpetuity price rises to $2.04/2%=$102, while the value of the cash perpetuity remains constant.

If inflation expectations rise to 2%, the RY becomes 4%. The cash perpetuity must fall to $50=$2/4%, because principal must be made whole for inflation and earn a real after-tax return equal to long term real per capita productivity growth. The gold perpetuity gains in value because according to RYT, gold oz. price moves with the RY, thus doubling to $4 and gaining 2% for productivity to $4.04/4%=$101 for 4% RY. The yield on holding cash, which is not interest-bearing, has a similar effect in that the principal value of the cash held now declines at 2% per year. Thus, the relative value of cash to gold is the same as that of the relative price of the two perpetuities, because the yield of holding cash and the rate of expected cash inflation are equal in magnitude and opposite in sign.

The value of a cash perpetuity is given by I/Y, wherein I is the fixed interest and Y is the required yield. The value of a gold oz. perpetuity in a fiat money economy is given by Formula 3:

P_{W}⁺¹={(Y⁺¹/Y⁰)×[P_{W}⁰+(P_{W}⁰×(I⁺¹+G⁺¹))]} (Formula 3)

In Formula 3, P_{W}⁺¹ is the gold perpetuity price per oz. at a next time t₁, Y⁺¹ is the expected required yield of the economy at time t₁, Y⁰ is the required yield Y of the economy at earlier time t₀ wherein t₀<t₁, P_{W}⁰ is the gold perpetuity price per oz at time t₀, I⁺¹ is expected inflation rate at time t₁, G⁺¹ is expected per capita real productivity (GDP) growth rate of the economy at time t₁, wherein world gold stock in troy oz. per capita is assumed constant and exchange rate is assumed constant. The cash perpetuity is valued by dividing the fixed interest (I) by the required yield (Y) at any point in time.

Y⁰ is the world required yield (Y) at time t₀ in accordance with Formula Y, wherein Ie in Formula Y is the expected world inflation rate for the next time period from time t₀ to time t₁ such that t₀<t₁, and wherein Te in Formula Y is the world blended effective tax rate for the next time period. Y⁺¹ is the world required yield (Y) at time t₁ in accordance with Formula Y, wherein Ie in Formula Y is the expected world inflation rate for a subsequent time period from time t₁ to time t₂ such that t₁<t₂, and wherein Te in Formula Y is the world blended effective tax rate for the subsequent time period.

Another way of evaluating the cash vs. gold perpetuities is to discount their cash flows. Consider the following example in which the expected rate of inflation is 2%/year. The cash perpetuity cash flow loses real values at a rate of 2%/year or the rate of expected inflation. The gold paying perpetuity gains 2% for inflation (on top of its gain of real per capita GDP growth) nominal value offsetting fiat money inflation, which it is not subject to, since the stock of gold in relation to real GDP has remained constant while that of money has risen to create inflation. This is seen by obtaining the present value (PV) of a fixed cash $2 interest discounted with no expected inflation at 2% real with a PV of $100, and a PV of $50 with a discount rate of an additional 2% for expected inflation: PV=ρⱼ₊₁$2/(1+0.02 +0.02)^{j+1} where “j+1” indexes successive periods of time over which PV is calculated to the point that each incremental future value adds negligibly to the present value. The gold perpetuity remains valued at $100 because the numerator grows at a nominal compounded value equal to expected inflation: $2 value of one oz. of gold×(1+0.02)ⁿ/(1+0.02+0.02)ⁿ.

Thus an investor would today pay twice as much in cash or $4 to buy an once of gold when the RY doubles to 4% from 2%.

It is also evident that while RY always produces an asset valuation, PV, net present value (NPV) and related discounted cash flows fail in cases where the growth rate of the numerator is equal to or greater than the discount rate. Consider the no inflation scenario where both the cash and gold perpetuities had the same $100 price. However, gold oz. price grows at a compounded real rate of productivity which is equal to the 2% discount rate. Thus the gold oz. price cannot be determined by the PV or discounted cash flow method: ($2×(1+0.02)ⁿ)/(1+0.02)ⁿ cannot be evaluated and results in an infinite PV. The RY method, however, predicts the correct $100 price because it specifies an immediate real required yield of 2%.

The local or national gold price would be determined by: the real GDP weighted exchange rates with other countries, the nominal change in world gold price due to world GDP growth per oz. of gold, and the domestic RY.

The local or national gold price may be determined by:

G_{c}=G_{w}×(Y_{c}/Y_{w})×[(1+W_{g})/(1+C_{g})] (Formula 4)

In Formula 4, G_{c} is the local or national gold price of a country at time t₁, and G_{w} is the world gold price at time t₀. Yc is the expected required yield (Y) of the country at time t₀ in accordance with Formula Y, wherein Ie in Formula Y is the expected inflation rate of the country for the next time period from time t₀ to time t₁ such that t₀<t₁, and wherein Te in Formula Y is the effective tax rate to an investor in the country for the next time period. Y_{W} is the world required yield (Y) at time t₀ in accordance with Formula Y, wherein Ie in Formula Y is the expected world inflation rate for the next time period from time t₀ to time t₁ such that t₀<t₁, and wherein Te in Formula Y is the world blended effective tax rate for the next time period. C_{g} is the country expected next period real per capita GDP growth rate and W_{g} is world expected real per capita GDP growth rate for the next time period.

It follows from Formulas 2 and 4 that the world gold price (Go) may also be expressed as the sum of the national gold prices weighted by their national real GDP shares of world real GDP. For example from Formula 4, the weighting factor on G_{c} is (1+C_{g})/Y_{c} for each country for determining G_{w} by summing over the weighted G_{c}.

### 3. Gold and Gold-Like Commodity Standard Asset Valuation

RYT and the RYM hold across both gold standard and fiat economies, the gold standard economies being discussed in this section.

Gibson's Paradox is the so-named empirical fact (from John Maynard Keynes) that under the classical gold standard in the UK 1820-1910, the British consol yield (a government bond perpetuity paying a fixed interest but no principal repayment wherein the fixed interest was fully convertible to a fixed amount of gold) moved with the price level (i.e., better correlation with the world price level than with the UK domestic price level) rather than with the rate of inflation or expected inflation as standard finance theory would predict (as proposed by Irving Fisher).

Academics (e.g., Barksy-Summers, Siegel, Fisher) have concluded that the best explanation is that a variable real yield is required by capital markets due to supply and demand fluctuations including those among monetary and non-monetary gold holdings. RYT however posits that the RY is a constant real required yield across time and financial asset classes, including gold.

Gold oz. can earn/yield the RY constant real required yield of 2% only so long as the gold supply grows at the rate of population growth. This is so because only then does gold growth result in real per capita productivity growth (since real GDP growth is the product of population growth x real per capita productivity growth which long term is about 2% for real GDP growth). In the long run, this yield per oz. is maintained by the economics of gold mining (net of occasional large discoveries which are cheap to mine).

Gold oz. is viewed as an investment, in contrast to a unit of fiat currency whose “yield” is expected to be the rate of national inflation.

The cost of gold mine extraction has been governed by the increasing physical difficulty of finding, extracting and reclaiming gold, increasing productivity due to technology gains, and increasing labor cost which due to competition for labor. The cost of gold must rise at the rate of long-term per capita real productivity growth else labor would migrate to competing industries. This net cost of gold has risen in the long term at the rate of GDP per capita or oz.

As long as the gold price per oz. also rises at GDP/capita, gold mines can thus maintain constant operating margins, which in turn must be competitive with operating margins in other industries in order to attract labor and capital. Increasing or decreasing gold supply from the rate of population growth has corresponding negative or positive price per oz. influence. An increased production rate above population growth would cause price declines which negatively affect operating margins; conversely, lower production growth causes higher prices and potential operating margins which would attract competition, again raising output and thus lowering prices to GDP/capita growth.

Thus, gold mine economics essentially assure that gold supply growth matches population growth, assuring that the gold stock per capita remains essentially constant.

The Friedman Quantity Theory of Money (QTM) (P=QV/M) states that price (P) is a function of the quantity of money supply (Q)×velocity of expenditure (V) divided by real output (M). That this principle holds is shown below in the graphic relation between total above-ground word gold stock during the gold standard divided by world real GPD and compared to the world price level. Proving that the world price level was a QTM function.

RYT states that gold oz. must be priced in relation to the RY or constant real approximately 2% yield equal to expected long term real per capita productivity growth. This is only possible when the gold supply is rising no faster than at the rate of population growth, with the ensuing world CPI falling at the rate of per capita productivity growth or an average of about −2% per year. The CPI falls because CPI/prices is/are measured in gold units and world real GDP is rising per oz. of gold, as it is per capita, at the rate of per capita productivity growth; thus gold oz. buys an increasing basket of real goods and services at the rate of per capita productivity growth. Gold oz. thus yields the RY or 2%.

The real RY is defined in absolute terms as a real basket of goods and services growing at 2% per year; with all asset prices set in relation to their point to point ability to earn or yield at least this quanta.

When the CPI is greater than −2% point-to-point rate of change or rising, then the price of gold falls against the RY. Conversely, when the CPI falls faster than −2%, the price of gold rises against the RY; which is to say that an oz. of gold buys more than a basket of real goods and services growing at 2% per year.

RYT asserts that any long term financial asset, including the consol, is priced so as to immediately yield an expected real, after-tax 2% constant yield. Under a gold standard, a fixed interest payment buys a constant basket or real goods and services when the CPI, measured in terms of gold as noted above, is constant. The degree to which the CPI in terms of gold oz. departs from a constant level directly and proportionately affects the real purchasing power of a fixed gold oz. interest paid on a perpetuity. In fact, as stated above, unless the CPI in terms of gold oz. falls at the rate of per capita productivity growth, an oz. of gold as an investment fails to yield the RY and the price of a consol would fall even in the presence of a constant price level so that the RY is realized.

It may be seen that any rate of change of price level in terms of gold oz. that is greater than a price level per oz. falling at the rate of real per capita productivity growth is actually a sustained rate of inflation in gold terms. For example, a doubled price level that remains constant in gold terms instead of falling at the rate of productivity growth per capita, is actually a sustained rate of inflation in gold terms, since gold oz. is not obtaining an increasing real yield equal to Y. Furthermore, this effect is cumulative in that the rate of change of gold oz. price level at any point compared with a price level declining at the rate of real per capita world productivity growth is the sustained rate of inflation/deflation as against an oz. of gold.

A doubling of the CPI, for example, causes the consol price to fall in half, doubling the yield given its fixed interest. Conversely, a drop in the CPI to one half causes a doubling of the consol price and half the yield. This empirical fact is required and predicted by RYT because a doubled CPI reduces the real yield of the consol in half; which, to preserve its real yield constant, must fall to half price or double its yield.

Thus a consol-type yield (C_{y}⁺¹) of a consol-type instrument traded within a world or national economy (characterized by a commodity standard in which a value of the world or national currency depends on a fixed exchange rate between money and gold) is given by:

C_{y}⁺¹=C_{y}⁰×[(1−T⁰)/(1−T⁺¹)]×[(Z_{g}⁺¹/G_{w}⁺¹)/(Z_{g}⁰/G_{w}⁰)] (Formula 5)

In Formula 5 for a world economy, C_{y}⁺¹ is the consol yield at time t₁; C_{y}⁰ is the prior or initial period consol yield at time t₀ such that t₀<t₁; T⁰ is the initial world investor effective tax rate at time t₀; T⁺¹ is the expected effective world investor tax rate at time t₁; Z_{g}⁺¹ is the expected total above ground world gold stock at time t₁; Z_{g}⁰ is the total above ground world gold stock at time t₀; G_{w}⁺¹ is expected world or national economy real GDP for the time t₁; and G_{w}⁰ is the world or national economy real GDP at the initial time t₀. The last expression [(Z_{g}⁺¹/G_{w+1})/(Z_{g}⁰/G_{w}⁰)]describes the consumer price level and the middle expression [(1−T⁰)/(1−T⁺¹)] expresses the effect of changing effective investor tax rate on the consol yield. Note that it has been shown here that the world price level under a gold standard is determined by the change in world gold stock ratio to world real GDP.

However, according to RYT, a gold oz. must yield the RY, which is real per capita productivity growth. This requires that the CPI in terms of gold must fall at that compounded rate in order for the consol yield to remain constant. Thus, the consol yield is a further function of the relationship between the actual CPI in terms of gold and a CPI described by the RY which is determined by a gold supply that grows at the rate of population growth where the CPI falls at the rate of real per capita productivity growth.

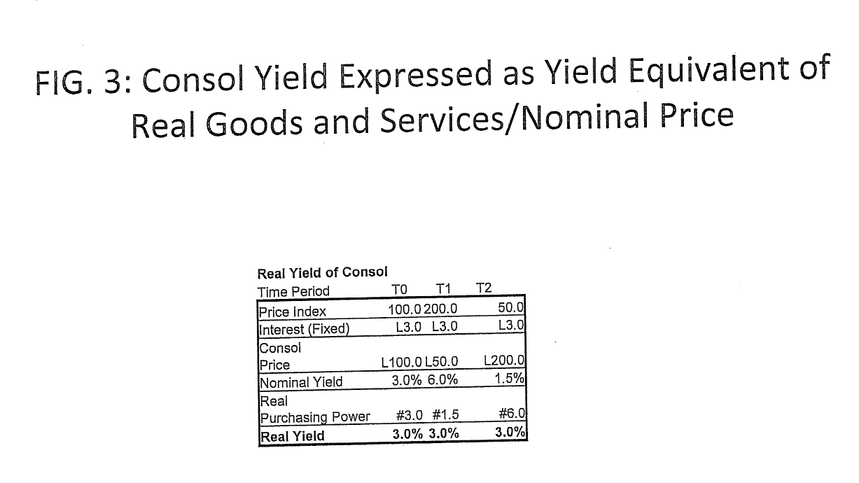

FIG. 3 is a table proving that the observed “Gibson's Paradox” effect is governed by a constant real required yield in terms of yield on nominal price of capital that returns a fixed real basket of goods and services, in accordance with embodiments of the present invention.

Under a gold standard with gold oz./capita constant, gold/oz. wages per capita are constant as real purchasing power rises at the rate of real productivity per capita. Since earnings per share must be constant in gold oz. because shares must grow at the rate of population growth, then return to equity must come entirely from dividends as earnings per share (EPS) do not grow; though their purchasing power does. Corporate balance sheets remain constant in nominal value but the shares grow in purchasing power if sold at stated value and used to purchase goods and services. Thus, the valuation of stocks under a gold standard with no EPS growth is given by expected Dividend/RY where the monetary value of dividends is divided by the pre-tax RY and gives the stock price and the earnings yield. Thus the stock price is the expected dividend payout/RY. Since EPS is constant, the dividend payout absolute amount cannot change unless the payout ratio to EPS does, perhaps in response to investor effective tax rate change to male the investors whole for the net tax effect.

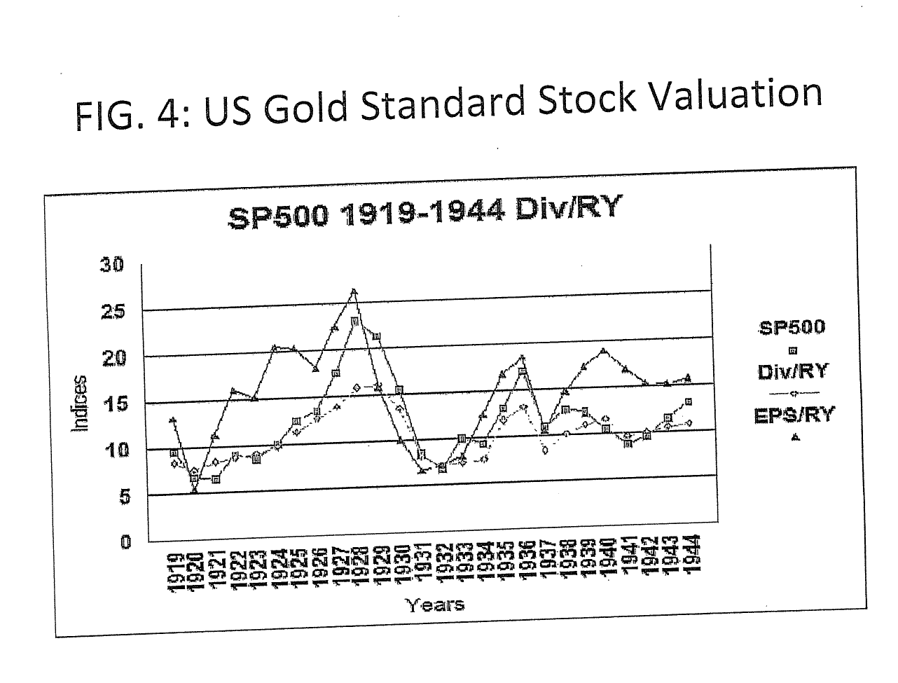

These predictions of RYT are fully supported by US gold standard data for 1919-1944 where the consumer price index remained constant as did earnings per share. Furthermore, stocks were valued precisely in accord with FIG. 4, discussed infra. In 1945, Word War 2 (WWII) ended and the US Treasury reduced gold backing for its bonds by 25.5%, resulting in an equivalent consumer price rate increase over the next three years.

The value of a stock index may be determined via Formula 6.

P=De/Y (Formula 6)

In Formula 6, P is the value of a stock index under a gold/commodity standard; De is the expected dividend of the index, Y is the pre-tax nominal required yield (long term; i.e., more than 20 years) real productivity growth rate/(1−effective investor tax rate)). The earnings yield is then E/P where P is determined as in Formula 6. The dividend payout ratio to earnings is determined by the pre-tax nominal required yield Y so as to at least hold stock price P constant in order to attract capital. Since under a gold standard there is no expected monetary inflation, the pre-tax nominal required yield Y involves no expected inflation term, leaving only the constant long-term real per capita productivity growth quanta of 2%. Thus Y contains no inflation term and the asset valuation characteristic is the dividend, not EPS. Note that even in a deflation, investors demand a return on capital equal to the RY constant of 2%; thus even long-term bonds must offer this after-tax yield.

FIG. 4 depicts results of Formula 6 as applied to the US SP500 1919-1944 (before the 1945 WWII end rally and the 25.5% reduction in gold backing of US Treasuries which resulted in a corresponding inflation rate boost), in accordance with embodiments of the present invention. The RYT SP500 dividend-based valuation formula results in a 13.9% average absolute variance from the actual SP500 annual values, while an EPS-based approach results in a far inferior 40.4% average absolute variance from actual values.

### 4. Bond Yield Curve Determination, Valuation, Yield and Term Structure of Interest Rates

This disclosure section comprises: long bond yield; bond coupon valuation; short term bond yield determination; inversion and sustained inversion; Fed Funds Rate determination; default premium determination; TIPS yield determination; and the return on equity (ROE) relationship to stock market valuation. The yield curve is interest rate of a bond versus time to maturity of the bond.

### 4.1 Long Term Bond Yield

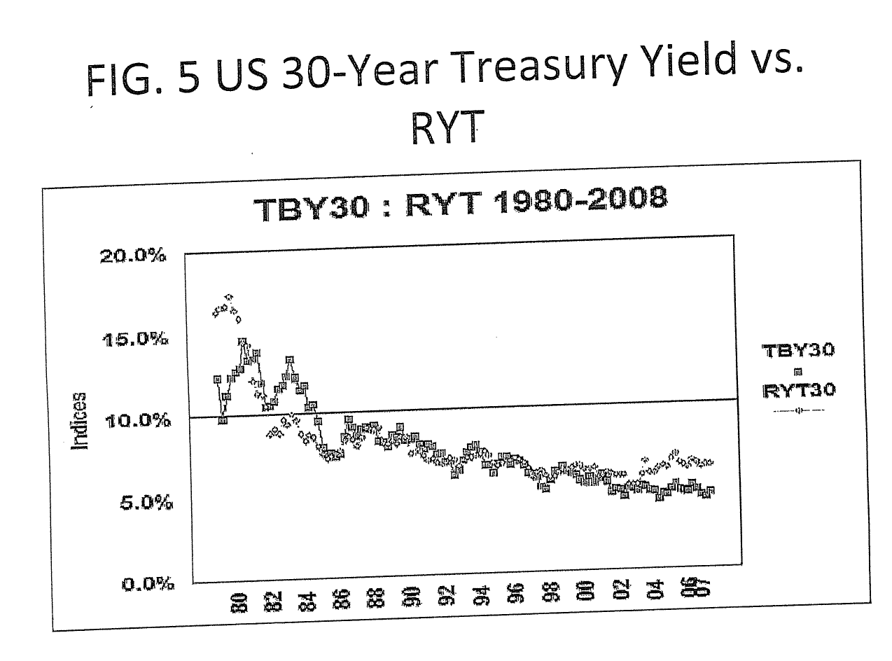

In Ser. No. 10/960,604, it is shown that the fiat economy long Treasury bond yield is largely determined by a constant real after-tax required yield equal to about 2% (which is determined and delimited by long term real per capita productivity growth). FIG. 5 shows the high correlation and absolute yield level coincidence between the RYT predicted (RYT 30) US 30-year Treasury yield and the actual Treasury Bond Yield 30 (TBY 30), quarterly, 1980-May 2008, in accordance with embodiments of the present invention.

The RYM-predicted inventive fact that the RY is constant is further supported by FIG. 3. Thus, under the UK pure gold standard, the consol yield was in fact a constant real yield for the duration of the 90+-year gold standard.

The long bond yield is further a function of far smaller impact on the total yield, of short-term interest rates as determined by the corporate return on equity (ROE) (below). In the short to intermediate term, the bond yield, and the yield/price of any security, may be affected by the actions of major investors or swings in aggregate investor activity that cause the price/yield to swing away from the values predicted by RYT. In the long run, RYT must hold.

For example, if the yield to maturity of a 10-year Treasury bond is 5%, its coupon $50 on a face value of $1,000; the next coupon payment date is 1 year away and the 1 year Treasury yield falls from 3.5% at the time of initial 10 year bond on the run pricing, to 3%; then the value of the coupon payment, if sold on the open market as a right to receive it in one year, rises: $50/(1+3.5%)=initial PV of $48.31; rises to $50/(1+3%)=new PV of $48.54; an increase of $0.23. This increase also affects the value of the bond itself so that its price rises accordingly; and its yield falls by $0.23/$1,000.=0.023%. The converse also applies.

Thus the long bond yield is modified according to the required yield changes on its stream of coupon payments according to the yield on bonds of like term to its coupon payments:

Y⁺¹={(I⁺¹+R−Q)/(1−T)]/(1+z) (Formula 7)

In Formula 7, Y⁺¹ is a yield of a long term Treasury bond at time t₁; I⁺¹ is an expected inflation rate for a next period from time t₀ to time t₁ such that t₀<t₁; R is the approximately 2% long term real per capita productivity growth rate (analogous to Y_{P} in Formula Y); Q is the growth rate amount by which real per capita productivity growth is expected to be less than the 2% long term real per capita productivity compounded growth rate over the remaining term of the bond; T is the expected effective tax rate for the composite bond investor universe exemplified by the tax rate on long term deferred tax investment account bond investors.

The parameter z is “a fractional short term interest rate effect on bond yield” which is defined as a fractional change in the yield of the bond due to valuation changes in the bond's stream of coupon payments stemming from changes in short term interest rates according to for Formula 8 (i.e., a change in bond price necessarily changes its yield/rate of interest which is value of coupon/price) (discussed infra) applying only to the sum of the present value of a bond's coupon payments, excluding the change in present value of its principal repayment.

### 4.2 Coupon Valuation and Bond Yield: Price and Present Value of Cash Flows

The present invention specifies that the required interest on each cash flow, including principal, and thus the discount rate on each of these should approximate the required interest on a bond whose term to maturity is equivalent to the term to payment of each cash flow. Thus, the term to maturity of each interest payment is the time remaining until the interest is paid. Therefore in accordance with the present invention, the expression for the calculation of the price of a bond and thus its yield changes to:

Bond Price=[(C₁/(1+i₁))+C₂/(1+i₂)² . . . +Cₙ/(1+iₙ)ⁿ+P/(1+iₙ)ⁿ] (Formula 8)

Formula 8 states the bond price of the bond (having a principal or face value, P) at a time to during which the bond exists, wherein n is the remaining number of consecutive coupon payment periods of time (from time t₀) until the bond matures into a repayment of P, and wherein n is at least 2. For m=1, 2, . . . , n, Cₘ is a designated coupon amount to be paid to the bond holder of the bond at the end of period m (in one embodiment, the coupon amounts are announced for the bond when the bond is first issued) and iₘ is an interest rate/yield of a similarly rated/callable bond having a maturity of m coupon payment periods from time t₀. A similarly rated/callable bond is a bond that is similarly rated and similarly callable (if the bond is callable). Thus, i₁ is the interest rate/yield of a similarly rated/callable bond that matures in 1 coupon payment period from time t₀, i₂ is the interest rate/yield of a similarly rated/callable bond that matures in two coupon payment periods from time t₀, . . . , and iₙ is the interest rate/yield of a similarly rated/callable bond that matures in n coupon payment periods from time t₀.

In the example above, a 10-year Treasury with on-the-run yield of 5%, $50 annual coupon payment and price of $1,000 would be priced by discounting each of its pending coupon payments by the interest rate required at the on-the-run date according to the like term to maturity Treasury bonds as the term to maturity of each of the coupon payments: successively: 1, 2, 3 . . . and 10 year Treasury bond yields.

This effect would result in a slightly lower yield than predicted by current models for fixed income instruments of given terms. However, this effect is offset by the capital gain resulting as the principal payoff time approaches and the remaining coupons are valued at the short-term, not long-term bond yield, which has the effect of increasing the price of the bond resulting in an offsetting capital gain against the slightly lower yield to maturity referred to above.

### 4.3 Short Term Bond Yield; ROE and the Term Structure of Interest Rates or Yield Curve

The short term bond yield is lower than the longer term bond yields because a) capital deployment lags result in less productivity earned over the term of the bond; b) the corporate sector faces the risk that it cannot earn at least 2% real after-tax in the short term; which risk is not present long term; thus, there is a negative return or yield premium for short term bonds. Apart from differences in short term (less than one year) vs. 1-year (the pricing mechanism for long-term bonds) inflation expectations (which play a role in the spread), the spread is the short term bond productivity shortfall vs. the long term bond divided by the effective tax rate.

No clear economic mechanism has been shown that determines the shape, slope and level of the yield curve and yield inversions relating shorter term yields to long term yields. Thus macro economics and finance (asset pricing) have not been definitively linked to date through either a general theory or empirical evidence relating macro factors and the yield curve. Analysts often cite the spread between short and long term bond yields. One could postulate that the spread of real after-tax yields is the key metric. Assuming that effective tax rates on both short and long term bond investors are similar and that the term structure of inflation expectations for each bond have similar effects on required yield, it can be shown that the nominal spread is as valid a metric as the real after-tax spread. The ratio and spread of bond yields of different terms to maturity would however change with changing inflation expectations according to their term structure.

The present invention shows and asserts that the mechanism in the real economy that determines the yield curve is the actual short and intermediate-term expected return on capital through return on equity (ROEe) as evidenced by the contemporaneous correlation among the change in real SP500 as-reported EPS, the yield curves as defined by the ratios of successive short term Treasury yields (3 and 6 month and 2 year) to the 10-year Treasury divided by their normal long-term ratio of yields, and the nominal and real after-tax yield spreads between the 3 month and 10-year Treasuries.

The ROE may be a domestic or aggregated foreign and domestic operations sourced corporate ROE. ROE itself may be difficult to measure due to the book value of unconsolidated subsidiaries, including foreign operations, whose earnings in whole or part are reported, but not the corresponding book value shares; or the use of off-balance sheet entities. The book value reported in the Fed Funds Flows could be used as a proxy, but its reporting is not timely.

Thus the yield of short term bonds is normally a negative spread from long term bonds whose yield has been shown herein to be determined by the RY pre-tax.

The normal spread between a short and long term Treasury bond such as the 3 month vs. 10 or 30-year Treasury (or any other combination) is evidenced when the ROE=RY and when the expected annualized rates of inflation for both bonds are the same, where Sₙ=(Y₁−Yₛ) where Sₙ is the normal spread, Y₁ is the long bond yield and Yₛ is the short term bond yield. When expected ROE or Rₑ is above or below RY (or alternatively, its long term trend), this short term Rₑ affects the arbitrage opportunities between ROE and bonds, affecting their yield and thus spread to long term bonds. ROE>RY will narrow this spread and ROE<RY will widen the spread. The other factors affecting the spread are relative expected inflation rates over the term of the short term bond vs. the long term bond up to one year, as RYM shows that the long bond is essentially priced according to a one year expected inflation rate horizon; any massive economic dislocations that would affect expectations about the long term real per capita GDP growth or productivity rate.

The spread between Treasuries of different maturities is a function of both relative tax rates and expected rates of inflation. It is uniquely disclosed here that it is also a function of relative expected returns on equity within the respective term structures of the bonds.

Y_{L}−Y_{S}=[min0{(maxY_{P}(R_{L})+I_{L})/(1−t)}−min0{(maxY_{P}(R_{S})+I_{S})/(1−t)}]+V (Formula 9)

In Formula 9 with respect to an economy, Y_{L}−Y_{S} is the yield spread between a long and short term Treasury bond; e.g., between a 30 year and 3 month Treasury bond (i.e., long term Treasury yield minus short term Treasury yield); maxY_{P}(R_{S}) is the expected short term real after-tax return (on stock market equity which determines bond yield) subject to a maximum of Y_{P} (e.g., 2%); maxY_{P}(R_{L}) is the expected long term real after-tax return (on stock market equity) subject to a maximum of Y_{P} (e.g., 2%); I_{S} and I_{L} are the expected annualized next period inflation rates over the respective terms to maturity of the short and long term Treasuries (i.e., “next period” means remaining term to maturity); t is the effective applicable investor tax rate on interest income; “min0” stipulates that the expressions (maxY_{P}(R_{L})+I_{L}) and (maxY_{P}(R_{S})+I_{S}) cannot go below 0, and V is the expected effect of yield curve inversion.

The parameter V is a “long bond expected capital gain or loss compensation” which is defined as a required short term bond yield equivalent increase to compensate for a long bond expected capital gain, which is its increase in price, or loss which both forces the short term Treasury yield up and the long term Treasury yield down/price up in accordance with Formula 8, which is illustrated in an example presented infra. Thus, a short term bond investor demands a yield increase exactly equivalent in value to the expected price increase of holding a long term bond instead over the term to maturity of the short term bond.

Inversion, as expressed by V in Formula 9, results when a short term bond holder, due to arbitrage conditions, must be offered the same short change in return/yield as a long term bond holder due to expected capital gains due to revaluation of one or both of the long term bond coupon payments and/or principal. Formula 9 shows that if expected short term ROE falls, then the coupon stream of a long term bond is upwardly revalued/lower yield/higher price on the long term bond. The yield on the short term bond must then rise to cause, under arbitrage conditions, investors to be neutral about holding either long or short term bonds for the effects of the lower expected short term ROE. This is the principal cause of inversion.

The minimum expected yields for either short or long term Treasuries are 0 unless investors fear that cash itself cannot be safely held as in the case where trust in the liquidity and solvency of the banking system is waning; and when therefore a risk-free yield may turn negative as investors bid up Treasuries as a means of storing cash safely.

The (V) or inversion premium occurs when a new expectation emerges where Rₛ will be lower than R current. In thus circumstance, near term long bond coupon payments and stock dividends become more valuable/are bid up in price because the short term required yield drops due to the expected Rₛ fall. The respective bond prices rise slightly, resulting in slightly lower yields and thus capital gains. Arbitrage conditions require that investors be indifferent between this expected capital gain and the current short-term yield of existing short-term Treasuries and like instruments, which then drives their prices down and yields up. The degree and duration of this expectation may result in inversion.

A long bond 5% equivalent near term coupon of say $50 on a $1,000 face value bond may be valued according to the near term interest rate of say 3.5% or $50/(1+0.035)=$48.31. If the ROE is expected to fall and the next period short term interest rate drops to 2.5%, then the value of the coupon payment gains: $50/(1+0.025)=$48.78. The long bond price rises by this amount and its yield falls by $0.47/$1,000.=0.0047%. Due to arbitrage, the short term bond must provide a return equal to this, therefore its price drops and yield rises. If the starting yield for a 3 month bond was an annualized 3.5% which using simple interest is $8.75/$1,000 face value (0.875%) quarterly; then the new yield must immediately make up the $0.47 long bond capital gain, rising to 0.875%+0.0047% =0.922% or 3.688% annual. The “V” is thus the required short term bond yield equivalent to compensate for a long bond expected capital gain or loss which both forces the short term Treasury yield up and the long term Treasury yield down/price up; which may lead to inversion. Inversion is sustained only when successive sequential expectations arise that are sufficient to sustain this effect and when the then current short and long term yields are of adequate magnitude to exhibit this effect.

In the long-run equilibrium state, BV/share grows with EPS which grows with GDP/capita growth. Even a flat EPS level with some retention of earnings results in book value (BV) growth and therefore a slowing ROE since the numerator is constant while the denominator grows at an ever slowing rate.

In accordance with the present invention, ROE is a prime determinant of the yield curve in that companies will pay an interest rate on short term debt that is not greater than near-term or term to maturity consistent expected ROE; else, ROE would be further diluted by an interest rate greater than the expected return on invested capital. As is evidenced in the series of graphs in this section, this effect is a) coincident and immediate; b) consistent across the term structure of interest rates based on term to maturity; c) shows that the Fed Funds rate follows, rather than leads real return on capital; d) explains the default risk premium on corporate vs. Treasury bonds.

Note that ROE falls even if EPS are constant, falling, or not growing as fast as in the past; because retained earnings or book value grows even if EPS is falling; thus the ROE falls even faster.

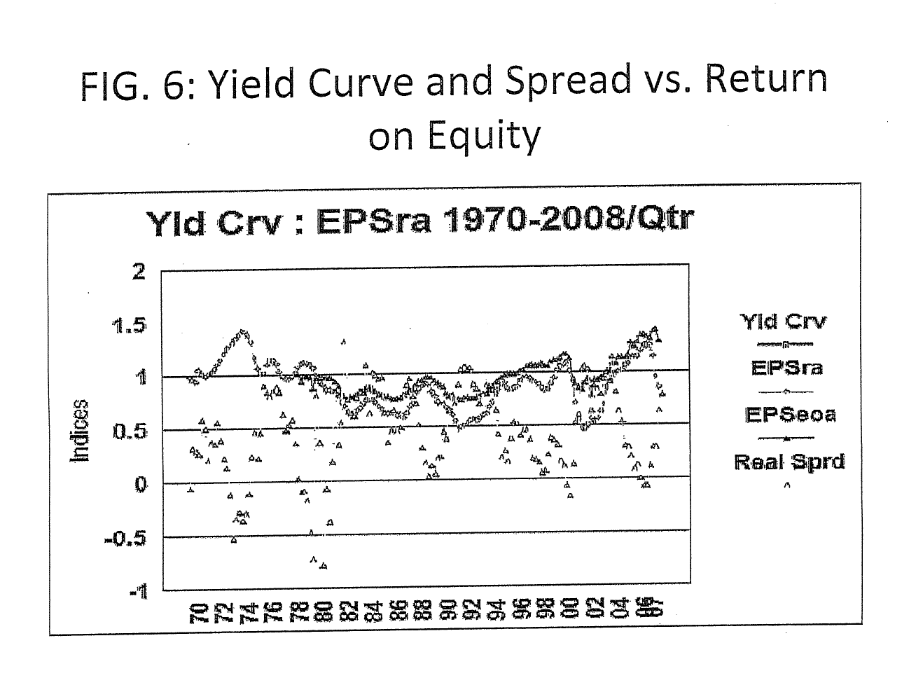

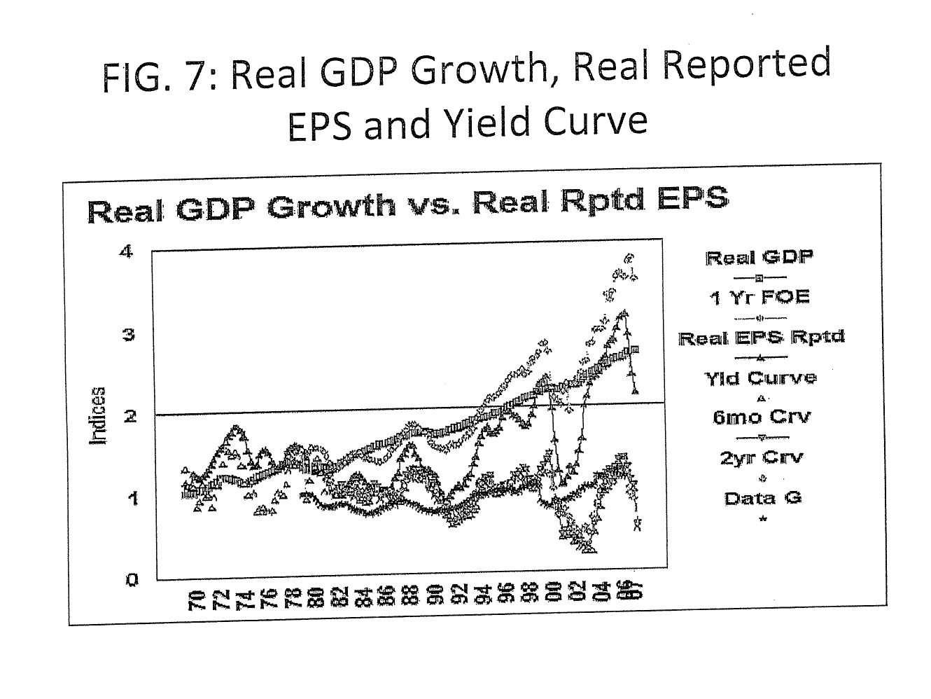

FIGS. 6 and 7 depict clear, contemporaneous and proportionate correlations among the above-mentioned economic phenomena with causation driven by the rate and direction of change of EPS.

“Real Sprd” in FIG. 6 shows the inverse quarterly real spread between risky Baa corporate bonds and like term to maturity Treasuries and return on equity on forward earnings (“EPSeoa”). “EPSra” is return on equity as reported.

FIG. 7 depicts the quarterly relationship among real SP500 reported earnings per share (EPS) (“6 mo Crv”) and the yield curve, shown as the ratio of short to long term Treasuries (“2 yr Crv”) depicting a co-varying and coincident relationship.

This disclosure asserts that more than expected macro-economic real growth deviation from the mean, Treasury and therefore commercial bond yield curves are determined by earnings expectations which more closely relate to repayment and default risk than general economic growth. This may occur for a number of reasons including: a) a corporate tax rate change which leaves more or less after-tax income for debt service; b) wage and other cost growth in excess of earnings or macroeconomic growth which also compresses before and after-tax margins and thus affects debt service capability (or sharp cost cutting through layoffs and wage freezes); c) competitive pricing pressures and changing cost of raw materials.

### 4.5 Fed Funds Rate

It is thought by some that the Federal Reserve Bank sets its Fed Funds rate so as to pursue either accommodative or restrictive policy with respect to achieving both inflation and growth targeting objectives.

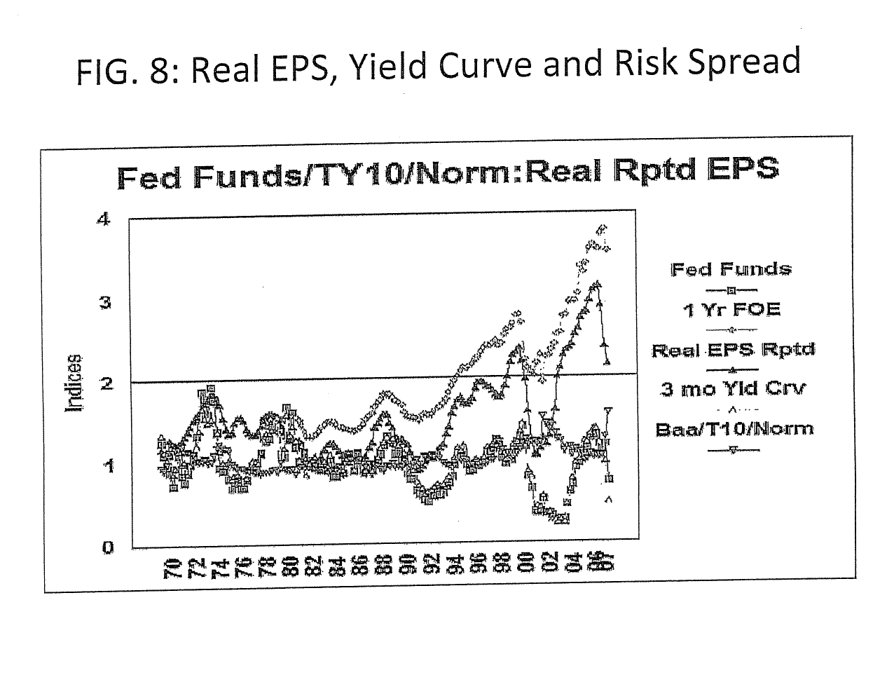

FIG. 8 depicts the ratio of Baa rated corporate (risky) bonds to like term to maturity treasury bonds (“Baa/T10/Norm”) compared with return on equity (“3 mo Yld Crv”). A coincident, inverse relationship is shown, quarterly, indicating that risk ratio rises. The Fed Funds rate coincides with the yield spread which in turn is determined by the immediate ROE. This fact appears to indicate that the Fed must follow, not lead market-determined yields. No leading or lagging effect of the Fed Funds rate appears from this quarterly record since 1970.

The ROE appears to similarly determine the relative yield spreads to long term bonds of bonds of shorter maturities including 6 month, one and two year Treasuries. FIGS. 6 and 7 show the ratios of quarterly yields of such bonds compared to 10-year Treasuries and further divided by their average such ratio. It is evident that for all terms to maturity, the ratios essentially coincide; which is to say, they and their spreads are similarly affected by changing ROE.

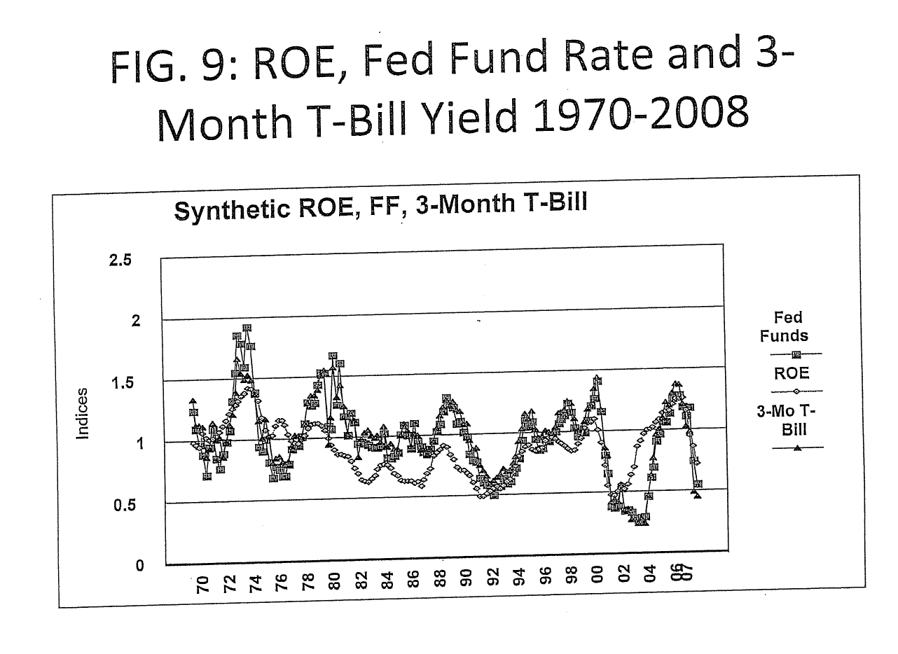

FIG. 9 depicts the coincident relationship, shown quarterly, between the Fed Funds rate, indexed to a beginning time period, and the national return on equity (ROE). Return on equity is calculated by relating the index of SP500 as reported earnings per share to the indexed corporate net historic net worth as reported in the Federal Reserve Bank's Fed Funds Flows quarterly report. FIG. 9 shows that the Fed Funds Rate follows ROE. ROE is calculated using SP500 trailing EPS indexed against the market value of non-financial corporate net worth obtained from Fed Funds Flows adjusted for share growth. Using forward or expected EPS obtains a very similar result. Since SP500 book value is difficult to accurately capture due to unconsolidated, foreign and other subsidiaries and factors, the Fed Funds Flow measure of net worth is used as a book value proxy, and SP500 EPS were used as a profit proxy indexed and compared as a ratio to each other; arriving at a “synthetic” ROE.

It would be difficult to argue that new federal funds action can affect past ROE or near-term expected ROE. Thus, the chain of causation is most likely that ROE drives short term market rates and requires the Fed to follow; not lead. This market mechanism is a result of still other factors affecting profits and is self-adjusting based on those conditions.

The ROE should also be related to credit risk perceptions and thus to the spread of risky corporate bonds over equivalent term to maturity Treasuries. FIG. 9 shows just this expected relationship.

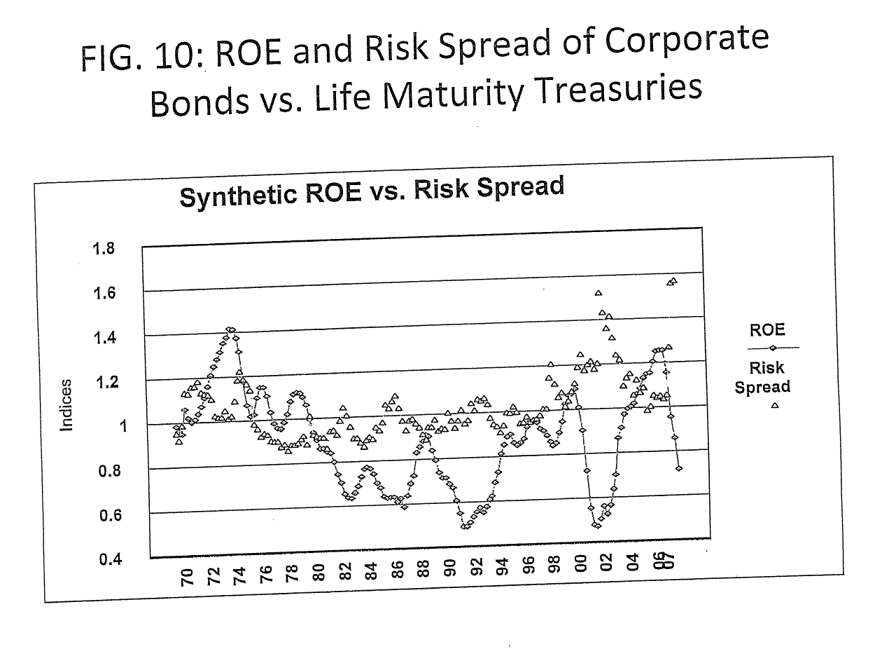

The risk spread is the ratio of Moody's Baa 10-year corporate bond yield to the 10-year Treasury divided by the average period spread for simplicity. The coincidental, not leading, inverse relationship to ROE is apparent from FIG. 10 which depicts the quarterly relationship between the risk spread between like term to maturity risky corporate bonds (Baa) to Treasuries, compared with the national return on equity (ROE). The ROE for FIG. 10 is calculated as described supra for FIG. 9.

### 4.6 Inversion

Normally, the maximum yield is the long bond yield as determined by a maximum RY of 2% real, after tax. This ceiling is caused by arbitrage among asset classes such as stocks and bonds where investors will bid the price of short term bonds to a maximum yield of 2% real, after tax no matter how much the short term ROE rises; resulting in a flat yield curve.

A shorter term bond yield rises above the long term bond yield and the 2% maximum real after-tax RY due to the coupon valuation effects under new falling near term ROE expectations disclosed above when they are of sufficient magnitude to cause the inversion. This effect is a function of the initial spread which may be very narrow due to ROE>RY and/or higher expected short vs. long term inflation rates. Thus: a) the short term bond yield spread between the long bond before the expected fall in ROE; b) the degree of expected ROE fall; c) the duration of the expected ROE fall. These factors simultaneously make cause a fall in long term interest rates and rise in short terms rates resulting in inversion.

Term of downturn via term of bonds inverting (e.g., 6 mo.; 1 yr. vs. degree of inversion from norm) may be caused by paying inducement to investors to hold short term bonds when reinvestment yield is expected to fall in the near future due to ROE/EPS decline. Thus ahead of such decline, some investors exit short term bonds at lower prices inducing others to hold them with higher yield to compensate for future expected lost yield. A long duration of 3, 6 month or 1 year Treasury yields to long bonds indicates waves of ever declining ROE/EPS expectations since a new round of 3 month T-bill investors would have bought these bills at lower yields with an initial expectation; which if it then worsens further for the next future period, results in prices of these new bills falling further, raising the yield high enough to invert. Then, a sustained very low short-term bond yield below the average relationship to the long bond, indicates the degree and duration to which real ROE/EPS growth is expected to fall below potential or GPD/capita growth; subject to a some positive minimum required yield on short term bonds.

Upon expectation of falling ROE/yield, an owner of short-term bonds must offer yield premium at least equal to expected long-bond yield decline/capital gain as inducement to result in a no arbitrage condition. Coupon payment would sell at premium/lower yield on coupon payment itself which also must be part of premium on short-term bond to obtain buyer. Sustained inversion is caused by sequential declining ROE/yield expectations.

A seller of a short-term bond, in the face of expected ROE decline, must offer a premium to a buyer who gives up the expected capital gain on a long term bond due to its expected yield decline. Therefore, the inversion arises if and when the yield increase is sufficient on a short-term bond to raise its yield above that a of a long term bond due to this effect. This is seen by considering that over the term of a given short term bond (e.g., a 3-month Treasury. As expectations build for a fall in ROE, the value of long bond coupons rise as does its price. To sell a short term bond, its yield must male whole a buyer for the opportunity loss of reaping a capital gain on a purchase of the long bond instead. The value of the coupons rises as the expected short term interest rate falls. If a buyer waits, the expectation is that the buyer must pay more for the same long bond. The short term bond yield thus becomes: coupon/(face value−expected long bond capital gain over the term of the short term bond)×4 to account for the four 3-month periods in a year.

Sustained inversion must be caused by new expectations of an additional ROE decline that again causes the expected long-term bond capital gain to be offset by another short-term bond yield increase through price decline.

Expected GDP short term growth is inadequate to explain inversion because it does not specify a ROE/ROA link to capital pricing directly while EPS and thus ROE can be impacted by foreign earnings and thus FX rates, corporate tax rate changes, changes in the RY, changes in COGS such as through margin contraction or expansion wherein for example wage increases faster than sales may erode margins, or job cuts drive cost lower faster than sales fall, resulting in higher margin and growth in profit and earnings per share.

There is no evidence that equities are priced with a “risk” premium in expectation of a EPS downturn since a short-term bond is not a proxy for a long-term investment like a stock. ROE change is directly proportionate to real risk-free Treasury yield spread, evidencing no risk premium factored into ROE. Short-term equity return volatility alone, if this is the definition of risk faced by the marginal investor, would require a huge yield/return required premium. However, because the long term investor/divestor is the highest bidder and lowest tax rate subject, no risk premium exists in bid.

4.7 ROE Effect on the Spread Between Risky and Riskless Bonds (Corporate vs. Treasuries)

For a given term (like term to maturity) of bonds, the normal default-risk determined spread between corporate or bonds at risk with respect to interest and principal (re)payment and Treasuries is determined when the ROE=RY; or alternatively, normal spread may be defined as when the ROE=long term or trend ROE. As near term ROE expectations change, the spread is affected in the opposite direction. As ROE rises above RY, the spread narrows; and conversely, as the near-term ROE expectation falls; the spread widens.

Y_{c}−Yₜ=(Min0(MaxY_{P}(Rₑ))−MaxY_{P}(Rₚ))/(1−Tₑ)² (Formula 10)

In Formula 10 with respect to an economy, Yₜ is the yield on a Treasury bond of like term to maturity of a risky bond having a yield Y_{c}; Rₚ is the aggregate economy expected return on equity over the term to maturity; MaxY_{P}(Rₚ) limits Rₚ to a maximum value of Yₚ (e.g., 2%); Rₑ is the expected aggregate return on equity of the entities issuing the risky bonds over the term to maturity; MaxY_{P}(Rₑ) limits Rₑ to a maximum value of Yₚ (e.g., 2%); Min0 assures that the Rₑ term never falls below zero; and Tₑ is an effective tax rate for an investor in the economy.

### 4.8 TIPS: Treasury Inflation Protected Securities

The Fed and the financial media have touted a first premise of the $412+ billion TIPS (Treasury Inflation Protected Securities) providing a guaranteed real yield. Academics and professional investors also believe a second premise that market inflation expectations can be derived by subtracting the TIPS yield from a like term nominal bond. However, taxes falsify the first premise for taxed investors, and have serious implications for the second premise.

The principal invested in a TIPS is grossed up for the actual consumer price index (CPI) semiannually, and interest is paid on the total bond value at the coupon rate. Federal current income or deferred taxes apply. The TIPS structure makes the investor whole for CPI and provides a real yield before, but not after, taxes. The after-tax real yield causes TIPS to behave in ways that have not been fully articulated by academics, professional investors or the Fed; and explains yield “anomalies” such as why the TIPS yield is higher than expected and correlates with the yield on nominal Treasuries of similar yield to maturity.

For example, a government guarantees the coupon and or principal payment of an otherwise risky bond and thus negates the bond's yield premium which corresponds to it's estimated net risk of loss. Thus, “g” in Formula 10 would fully offset the effects of relative declines in “R” or return on equity.

Yₜ=[(Rₙ+(iₑ×t)]/(1−t) (Formula 11)

In Formula 11, Yₜ is the yield on a TIPS bond of like maturity to a nominal bond whose real, after-tax real yield is Rₙ and iₑ is the expected inflation rate; t is the tax rate to the TIPS investor.

As an example, a 10-year Treasury yield is (2% RY+2% expected next year inflation rate)/(1−20% effective rate)=5%. A TIPS with the same term to maturity must yield the same 2% real required after-tax yield and the pre-tax value of the taxed inflation gross up. Thus: (2% RY+2% expected inflation rate×20% effective tax rate)/(1−0.2)=3%. The 2% spread is the expected inflation rate if inflation expectations and effective tax rates for both investor sets are the same.

The TIPS yield above the required real after tax yield for like term to maturity Treasuries compensates the investor for taxes on both the coupon yield and the inflation gross-up, adjusted for timing difference in receipt of each.

Consider the Oct. 29, 2007 10 year TIPS yield of 2.04% and the 10 year nominal Treasury bond yield of 4.38%. The profession thinks that the market expected average rate of inflation is (4.38%−2.04%)=2.34%. The expected after-tax real yield for the TIPS is [(1−35% assumed top tax rate)×(2.04% coupon+2.34% expected inflation)]−2.34% expected inflation=0.5%, the same as for the nominal bond: (1−0.35)×4.38%−2.34%=0.5%.

What happens if actual inflation averages 5%? The math shows real after-tax TIPS annual yield of −0.4% and −2.15% for the nominal Treasury at 35% tax rates. The TIPS does mitigate the after-tax impact of inflation; but does not remove it. In fact, the only way to guarantee a real bond yield is to exempt it from tax and offer the inflation gross-up. Then the yield will be real. The current TIPS yield is unquestionably nominal based on two risky sets of expectations: effective tax rate and inflation. This fact also means that the price or principal value of TIPS are at risk merely due to changes in inflation expectations.

If the TIPS yield is real, why would it correlate (move up and down) with the nominal bond yield? This would only happen if the real yield required by the market was changing. It should not happen if only inflation expectations were changing. However, as shown above, the TIPS yield is nominal, just like the nominal bond yield; so a yield correlation is predicted.

Now consider expected inflation and effective tax rate assumptions. It is implicitly assumed that TIPS and nominal treasury investors have the same inflation expectations (this part the Fed is aware of and has questioned). What if they have different effective tax rates? If TIPS investors are more sophisticated, richer, and therefore face a higher expected tax rate; any attempt at deriving inflation from the yield spread fails unless these tax rates are known. Further, consider emerging upside risks to the top tax bracket due to a presidential election outcome uncertainty.

For example, at a 35% expected effective TIPS investor tax rate with 1% required real after-tax yield and 2% expected inflation, the nominal TIPS yield would be 2.61%. The nominal bond yield with the same 2% inflation expectation but 25% average effective investor tax rate would be 4%. The spread is 1.39%, which is far LESS than the 2% mutually identical inflation expectation.

Since it is widely thought that TIPS yields are real, the fluctuations in TIPS yields are considered proof of a varying real required rate of return—this is very suspect based on the above tax effect analysis. In fact, a very strong case has been made herein that the required real long term after-tax rate is constant.

In summary: TIPS are risky due to uncertainty in both effective tax rate and inflation which can result in negative real after-tax yields to investors. The yield spread with nominal like term bonds does not necessarily reflect market inflation expectations—only if tax rates and inflation expectations for both investors groups are the same; which is unlikely with regard to the former.

### 4.9 ROE and Stock Market Valuation

While the valuation of the stock market based on forward expected earnings per share is essentially as disclosed herein, short-term ROE will affect this valuation through the valuation of near-term dividends. This valuation is similar to that of the long term bond in that near-term dividends will be bid up in value as the immediate expected ROE falls, and down in value as this expected ROE rises. Accordingly, the value of an equity index or dividend-paying stock will be slightly affected, net of any expectation about changes in the amount of the dividend.

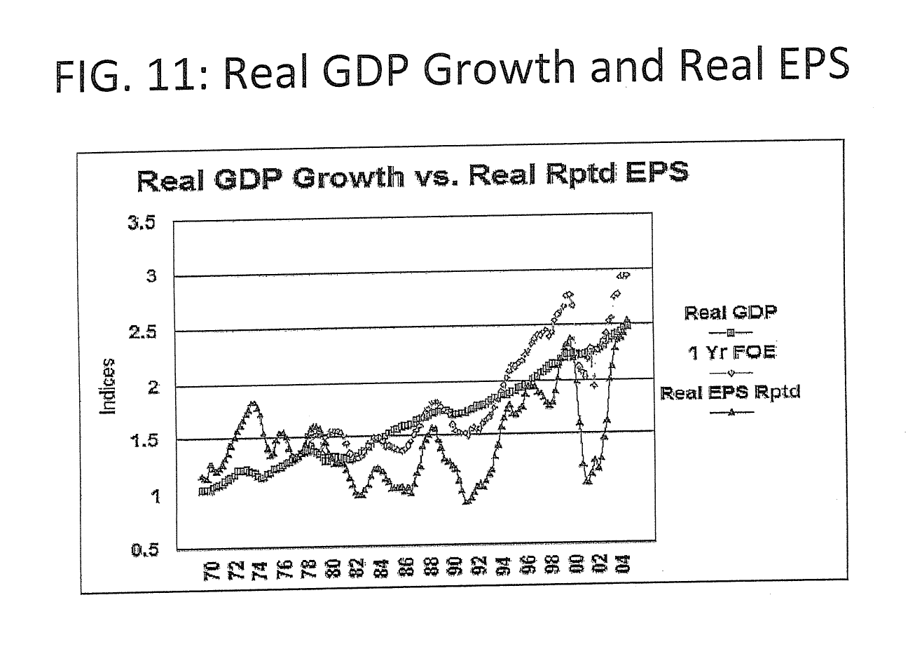

FIG. 11 depicts the quarterly relationship between real US GDP indexed to an initial time period and both real expected next year SP500 earnings per share (EPS) (FOE) and as reported earnings per share. FIG. 11 shows a very generalized directional relationship, but large time period to time period variability in relationship between real GDP and EPS.

### 5. Stock Index and Stock Valuation; RY and ROE

Next discussed is RY impact on ROE and EPS and a new method of EPS forecasting based on change in RY is disclosed.

In the long run, EPS growth in aggregate is delimited by GDP/capita growth since share growth must equal population growth as shown in FIG. 11. Specifically, FIG. 11 depicts the quarterly relationship between real US GDP indexed to an initial time period and both real expected next year SP500 earnings per share (EPS) (FOE) and as reported earnings per share.

FIG. 11 shows a very generalized directional relationship, but large time period to time period variability in relationship between real GDP and EPS. Change in corporate tax rates and foreign earnings, for example, may affect EPS growth rates for extended periods of time. While earnings growth is somewhat correlated to economic growth (with the same factors impacting each metric to some degree), earnings are also impacted by foreign operations, exchange rate conversion, change in profit margin as may be impacted by changes in costs such as labor and energy, asset impairment, changes in the corporate tax rate and: to changes in the RY which in turn drive the ROE or return on equity. For example, a decrease in the required yield, due to either or both a tax rate decrease or expected inflation rate decrease, will cause corporate target ROE to decline to approach the required yield.

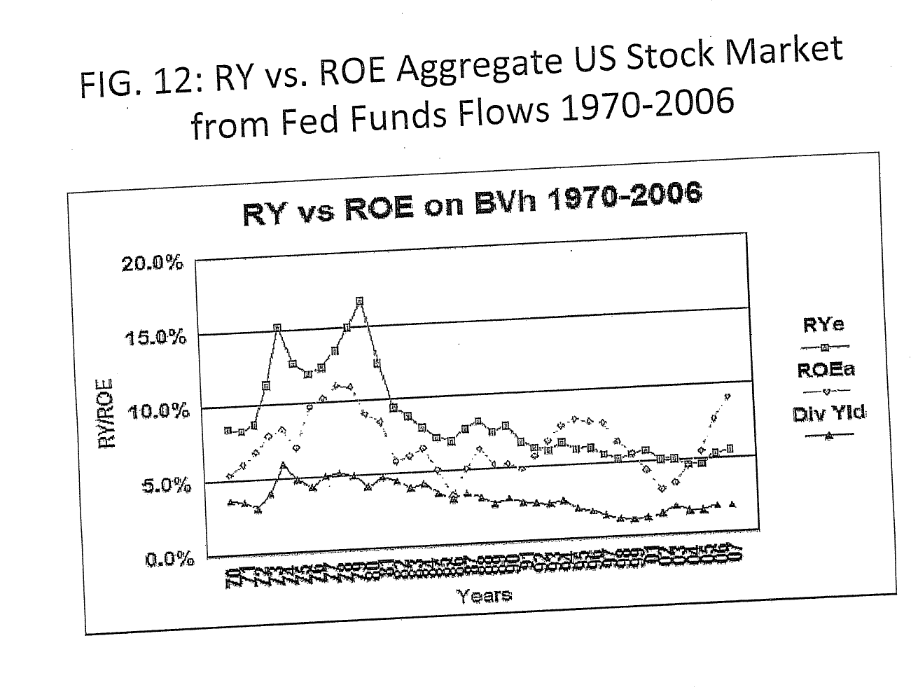

The concept that EPS growth is determined by the ROE which in turn is determined by the RY is introduced here. The corporate ROE drives EPS from which dividends are paid and retained earnings which determine book value growth. Graphic evidence that the RY determines ROE is presented in FIG. 12. Specifically, FIG. 12 depicts the annual relationship among the Required Yield (RY) as defined herein, the national return on equity (ROE) as defined herein, and the dividend yield of the stock market as computed from Fed Funds Flows data.

ROE is determined by the required yield RY. Where RY>ROE, dividend yield must male up return gap to investors. Since ROE is determined by RY, so is EPS growth. For example, despite a growing economy, if the RY falls proportionately more than normal GDP/capita growth, EPS will fall. Thus a new method of aggregate EPS forecasting is introduced:

E⁺¹=E×(1+G⁺¹)×Y⁺¹/Y⁰ (Formula 12)

In Formula 12 for an economy, E⁺¹ is an expected or next period earnings per share of a stock index; E is a current period EPS; G⁺¹ is an expected next period GDP per capita growth rate of the economy; Y⁺¹ is the next or future period expected required nominal yield of the economy; and Y⁰ is the current period required yield of the economy.

Y⁰ is the required yield (Y) at time t₀ in accordance with Formula Y, wherein Ie in Formula Y is the expected inflation rate for the next time period from time t₀ to time t₁ such that t₀<t₁, and wherein Te in Formula Y is the effective tax rate for the next time period. Y⁺¹ is the required yield (Y) at time t₁ in accordance with Formula Y, wherein Ie in Formula Y is the expected inflation rate for a subsequent time period from time t₁ to time t₂ such that t₁<t₂, and wherein Te in Formula Y is the effective tax rate for an investor for the next time period.

Thus the aggregate market may experience flat or lower EPS level despite GDP/capita growth and no recession if the Y falls enough; and conversely, EPS level may rise much faster than GDP/capita growth if the RY rises enough.

Note that in order for ROE to satisfy the RY, it must exceed GDP per capita growth to offset taxes. How is it possible for ROE to exceed GDP per capita growth? The answer is that companies delay increases in certain factor payments; specifically, labor and real estate. For example, corporate sales and profits generally rise at GDP per capita on a per share or per company basis; but wages are increases only once a year in a catch-up adjustment. This lag in compensating labor and real estate allows for a higher ROE.

Earnings growth expectations in excess of GDP/capita growth that extends beyond the next period may be valued according to the RY method as disclosed herein.

Pₑ=E₁/(Y)+[Σₘ(Eₘ₋Eₘ₋₁(1+gₘ))/(1+Y)^{m}]/Y (Formula 13)

In Equation (13), Pₑ is the current price of a stock index or stock with EPS growth in excess of GDP per capita growth for n successive periods of time. For the time period index m (for m=1, 2, . . . , n), gₘ is the expected GDP per capita growth rate in period m, Eₘ is the expected actual EPS of the stock index or stock in period m subject to Eₘ>gₘ, and Y is the required yield (pre tax with Te=an effective expected investor tax rate in Formula Y, at the first period inflation rate for Ie in Formula Y), and the summation Σₘ is from m=2 to m=n. The factor (Eₘ−Eₘ₋₁(1+gₘ)) is a weighted difference between the EPS of the stock index or stock in successive periods (m−1) and m. with weights (1+gₘ) and 1 for Eₘ₋₁ and Eₘ, respectively.

For example with n=2: a stock index has expected EPS first year (m=1) of $1 and Y=5%; therefore the first term is Pₑ=E₁/Y=$11.05=$20. If year 2, (m=2) the EPS is expected to rise by 15% to $1.15 while GDP per capita growth is expected to be 5% following which, EPS growth is expected to keep pace with GDP per capita growth. Then (E₂−E₁(1+g₂))/(1+Y)²]/Y={[(1.15−1(1.05)]/(1.05)²}/0.05=$1.814; and the total price (Pₑ) of the stock is a sum of the two terms; i.e., Pₑ=$20+$1.814=$21.814. One of normal skill in the art can compute price-earnings ratios and other metrics from this disclosure.

Next discussed is dividend valuation in relation to short-term ROE and yield curve term structure of interest rates.

Just as it has been shown here that bond coupon yield is affected by short-term ROE, so too are dividends which, like bond coupon, are near-term cash flows. An ROE downturn resulting in low short-term Treasury rates (e.g., 3-month T-Bill) will likewise affect the valuation of near-term dividends. If dividends were sold separately from the issuing stocks, a dividend price/yield inversion is likely to occur compared with the expected earnings yield of the issuing stock; just as in the Treasury bond market.

Next discussed is low and no-EPS growth stock valuation.

Stocks whose EPS do not grow at the rate of pre-tax RY must pay dividends to investors so that investor return meets the RY of 2% real after-tax. The simplest case is a stock with no or negative EPS growth where investor returns come solely from dividends (yield). In this case the stock is valued solely based on its dividend because there are no expected capital gains accruing from EPS growth, so that the dividend yield=RY:

P=D/Y (Formula 14)

In Formula 14, P is the price of a no expected EPS growth stock (i.e., a stock whose earnings per share are not expected to grow) or index of such stocks paying a dividend (D) per unit time. The required yield (Y) is at time t₀ in accordance with Formula Y, wherein Ie in Formula Y is the expected inflation rate for the next time period from time t₀ to time t₁ such that t₀<t₁, and wherein Te in Formula Y is (in one embodiment) the effective tax rate for the next time period. In another embodiment, Te in Formula Y may reflect the dividend tax rate alone, instead of the blended capital gains/dividend effective tax rate for stocks with both expected capital gains and dividends.

A stock whose EPS growth is positive by less than pre-tax RY must pay dividends to assure total return to investors equal to RY. In this case, the dividend yield must equal RY−expected stock EPS growth. For example, if the RY is 6.67% and EPS growth is expected to be 5%; dividend yield must be 6.67% RY−5% EPS growth expected=1.67%.

Furthermore, a stock whose positive EPS growth is expected to be less than the market's aggregate GDP/capita growth, say 3%, will have a lower P/E because of the above requirement that its dividend yield be higher than that of the market. Furthermore, such a stock will have a higher than market dividend payout ratio to earnings.

A stock must yield the RY to investors. This is accomplished through either or a combination of EPS growth and dividend payout/yield. To the extent that a stock's EPS grows slower than GDP per capita growth, its dividend yield must be greater to make up the after-tax difference. Thus if the Y is 6.67% comprised of 5% GDP per capita nominal growth and therefore EPS growth; and 1.67% dividend yield; then a stock with 4% expected EPS growth must have a 2.67% dividend yield and will be priced accordingly.

The rate by which EPS growth is below that of expected long-term GDP per capita growth for an economy must be added to the required dividend yield. The market required dividend yield is Y−(g+i) where g is long term real expected per capita growth and i is expected next year inflation rate (which together are long term nominal GDP per capita growth) (from Formula 1B). A stock with expected EPS growth less than (g+i) will have a dividend yield D_{y} shown infra as Formula 15.

Therefore a stock or stock index with expected EPS growth less than expected GDP per capita growth and paying a dividend priced so that its dividend yield (D_{Y}) is:

D_{y}=Y−E₁ (Formula 15)

In Formula 15 for an economy, D_{y} is the dividend yield of stock index or stock, Y is the nominal economy's after-tax required yield (i.e., Te in Formula Y) at the time period's inflation rate for Ie in Formula Y; and E₁ is the expected long term growth rate of the stock index or stock's EPS which is lower than the long term GDP per capita growth rate (g+i), wherein g is an expected GDP growth rate per capita for the economy, and wherein is an inflation rate for the economy.

For example, both the market and the stock in question have next period EPS of $100/share with the market paying an expected dividend of $25/share and valued at $1,500/share. If the low EPS growth stock pays the same dividend; it will be valued at $25/(6.67%−5%+(5%−3%))=$681.82 and yielding $25/$681.82=3.67% with EPS growth of 3% and total return to investors of RY or 6.67%, which is the same as that of the market with 5% EPS growth and 1.67% dividend yield. Such stocks will have a higher dividend payout ratio because their ROE is below market. Investors would not permit a stock with EPS growth less than RY not to pay a dividend since retaining earnings would be wasted resulting in a declining ROE. Note that only if full earnings are paid out as a dividend will a stock with no or low growth EPS have the same P/E as the market; otherwise, if some earnings are retained, the stock's P/E must be lower due to the lower expected ROE than market.

A growth stock must have expected EPS growth at least equal to RY so as not to be forced to pay a dividend by its investors. A growth stock is therefore defined here as a stock whose expected EPS growth is at least equal to RY. Such stocks are very susceptible to revaluation if EPS growth is not maintained to expectations.

A growth stock is thus defined as a stock which is not required to pay dividends to return RY to investors.

RYT has shown that the highest bidder is the long term investor-divestor who, over such a horizon, incurs and expects no effective return risk/deviation from the long-term real after-tax return of long-run GDP/capita growth. Furthermore, the effective tax rate is the lowest over this horizon. This investor therefore, bids point to point with no risk premium in the bid; which is equal to the RY with the lowest effective tax rate. Any other investor faces both a higher effective tax rate and return risk over shorter horizons but cannot underbid the long-term investor thus embedding a risk premium.

An individual stock is bid to the RY despite unique risks because the highest bidder is an index or fund of stocks or an investor who incorporates said stock into a portfolio which effectively diversifies away unique stock risks.

While the RY may temporarily be increased for an excess long term risk-free yield above the RY; the RY is not affected by a short term excess yield such as evidenced by yield inversion. A short term yield cannot affect a required long-term return.

The concept of effective investor tax rate is introduced here. The effective investor tax rate in a deferred tax investment account is far less than the stated investor tax rate applied to gains withdrawn at a point in time. This is because dividends, capital gains proceeds and new investments have been made on a compounded basis in the account before tax is paid upon withdrawal. For example, a stated 40% top investor income tax rate applied at withdrawal from a deferred tax investment account after 30 years of compounded 6% annual returns is not 40%; but rather 23%; since the resulting after-tax compound rate of return is 4.6%; or 23% less than 6%; after 40% of gains have been taxed away. Similarly, effective capital gains tax is less than the stated amount after extended periods for the same reason.

Tₑ=(t_{bt}−tₐₜ)/t_{bt} (Formula 16)

In Formula 16, Tₑ is the effective tax rate; t_{bt} is a before tax compounded rate of total asset return; tₐₜ is an after-tax compounded rate of total asset return; both over period 1 to n years (n at least 2).

RYT and NPV are contrasting methods of asset valuation. A simple example involves a riskless asset returning a $1 annual simple interest per year with no expected inflation or applicable taxation. RYT values this asset at $1/2%=$50. NPV also values this asset at $50. However, if the interest grows at a compounded 2% per year; RYT would also value this asset at $50 at time one, and successively 2% more per year. NPV however returns an undefined infinite value for this asset because the growth and discount rates are the same. NPV would also greatly over-value this asset even if taxation were introduced.

### 6. Economic Growth and Earnings Impairment Forecasting

It is widely acknowledged that economics and finance lack adequate tools to forecast major turning points in economic growth and corporate profits and earnings (Woolridge, J. Randall; “The Accuracy of Analyst's Long-Term Earnings Per Share Growth Rate Forecasts”; The Pennsylvania State University, January, 2008); and especially so for recessions/depressions. This disclosure teaches methods of ascertaining the degree and duration of growth impairment in one or more economies.

The concept that the economic growth (GDP growth) is a return generated from human, financial and physical capital is introduced. Second, that the approximate value of said assets is determinable in that annual nominal economic output (GDP) is a function of return on said assets (existing and new over the course of a period of time), with the current $14 trillion (T) US GDP implying $14T/6% (under normal growth: 3% real output driven by population growth, real per capita productivity growth and approximately 3% inflation) or $233T of assets such as (Fed Funds Flows Statement) $46T non-financial debt, $10T equity in residential real estate, $20T stock market value, $15.6T foreign-owned assets producing domestic GDP (from BEA International Investment Position of the US), infrastructure such as public roads, dams, airwaves, mineral and other natural resources, public lands, school and university assets and those of non-profit entities; intellectual property, and human capital such as skilled medical, scientific, legal, technical and other professionals; consumer equity in capital assets such as rolling stock (which according to the BEA's Current Cost Net Stock of Fixed Assets and Consumer Durable Goods is another $21T including Government fixed assets; but excluding measures of intellectual property, mineral and other rights, for example). Thus, at least one half of GDP can be shown to be the result of a return on identifiable financial and physical assets of the US economy; with the other half being a return on labor. Third, that an estimate may be made of impairment of normally earning assets, multiplied by the lost return of said assets may then be compared to expected or normal real GDP growth to assess a probable negative impact on real growth. Fourth; this estimate comprises a comparison of normal real GDP growth ($14T×6% nominal and 3% real=$840 billion nominal and $420B real normal next year growth) to a prospective subtraction of lost return on impaired assets first against the real component of GDP growth. This theoretical framework combines the afore-mentioned factors and thus permits estimation of future growth impairment in degree and duration.

Duration is a function of lag in the effect of asset impairment, and the net effects of incremental asset impairment and lost returns vs. the normal tendency toward growth.

Three example causes of growth impairment are: a) economic shock such as natural disaster or price shock for a necessary consumable commodity such as oil; b) a change in the Required Yield (RY) and/or corporate ROE to attain the RY as may be driven by a change in expected inflation or effective corporate or investor tax rate; and c) impairment in the expected return and thus value of major asset classes such as real estate, mortgages, mortgage derivatives, corporate loans, inventory; job/income losses or other assets.

A further example is the government inducement to build capital in targeted sectors with favorable tax policy, below-market interest rates, direct subsidies, monopoly grants and other favors. These assets will generally earn a lower rate of productivity growth than market-driven asset building. The proportion of such assets in the economy will accordingly slow the overall growth rate of the economy. An example of this is the U.S. housing stock to the extent that it exists due to below-market costs driven by tax policy and interest rate subsidy to Fannie Mae and Freddy Mack which guarantee or buy a significant portion of new mortgages.

It should be recognized that real growth may be viewed as absolute total and per capita real growth; with only the latter affecting the standard of living. The total is driven by population growth as well as productivity. A recession may occur in terms of per capita or both, with an aggregate recession being deeper than a per-capita recession and affecting both.

For example a quarterly decline in residential real estate value from $19T to $18T at an assumed 6% ROA would result in a $60B subtraction from real growth. A $10 increase in the average price of a barrel of oil over a quarter multiplied by the #1.9 billion barrels consumed by the US in a quarter would further subtract $19B from the average normal real quarterly GDP growth of $105B. Note that a sharp increase in the nominal RY would cause a fall in stock and debt asset prices, which is considered an impairment here. Job growth less than the rate of population growth, especially net job losses; and income growth less than GDP/capita are also human capital asset impairment. As a net worth of households declines or fails to exceed GDP/capita growth, households must spend less and save more to assure a future standard of living which net worth growth due to asset value increases is no longer providing. This drop in the rate of spending growth becomes a drag on the real economy. This theory may be expressed as:

Gₑ⁺¹=G⁰+[((A₁⁺¹−A₁⁰)×Y)+ . . . +((Aₙ⁺¹−Aₙ⁰)×Y)] (Formula 17)

In Formula 17 for n asset classes, Gₑ⁺¹ is an expected GDP of an economy such as an economy of a country or the world (i.e., a group of representative countries of the world) for time period 1; G⁰ is the GDP of the country or the world for time period 0 which immediately precedes time period 1; A₁⁺¹ is an asset class' (such as the stock market; the value of commercial or residential real estate net of debt; the value of the bond market; foreign investment; intellectual property; public tangible infrastructure such as roads and bridges, parks, airwaves; work force, etc.) expected value with respect to the assets in each asset class at the end of time period 1; A₁⁰ is the value of asset class 1 at the end of time period 0; Aₙ⁺¹ represents expected value of asset class n at the end of time period 1; Aₙ⁰ represents expected value of asset class n at the end of time period 0.

The required yield (Y) is at time t₀ in accordance with Formula Y, wherein Ie in Formula Y is the expected inflation rate for the first time period from time t₀ to time t₁ such that t₀<t₁, and wherein Te in Formula Y is the effective tax rate for the first time period.

This formula shows that GDP is a return on assets including all forms of net debt outstanding, equity, net physical capital owned free and clear of debt and equity, human capital/work force; etc. A real GDP normal growth rate of 3% may be entirely offset and turned negative if sufficient asset value impairment occurs multiplied by its required return wherein that lost return offsets some or all of real GDP growth.

A sharp increase in the RY may cause growth impairment through several mechanisms. First, asset prices fall; most obviously, stocks and bonds. Through the mechanism in Formula 17 above, the decline in asset values times their expected return may be a subtraction to real growth. Secondly, new investment faces a higher hurdle because of the greater RY; thus the rate of new investment growth for this reason alone, may suffer and become a drag on growth. Third, corporations will cut costs (including jobs; or hire more slowly than population growth thus raising unemployment rate) so that their ROE matches the new RY as quickly as economically reasonable. Job and income losses cause consumption losses and so on.

Growth is assumed to be a normal state. Thus growth impairment is assumed to occur incrementally or at the margin. Thus an asset impairment's effects do not recur once subtracted; except to the extent that further impairment or impairment of other assets occurs.

Economic conditions through 2008 were characterized by falling residential real estate prices, write-downs of mortgage-backed and other loans exceeding $250 billion, falling stock market and falling value of consumer credit loans due to rising delinquency rates. The lost returns on the impairment of these assets, combined with net loss of jobs, incomes and reduced spending indicate major subtractions from real growth. In the present case, the inventor expects that residential and commercial real estate will decline after 2008 at least 30% in value from peak; representing a loss of at least $7T; coupled with related loan losses, job and income losses, losses on corporate and other loans, and the effect of increase in oil prices times US oil consumption in relation to GDP. A loss of $7T or more in asset values x a 6% assumed ROI reduced real GDP growth by $420B with oil causing an additional $70B loss. Losses in jobs and other loans plus losses on stock market investments made times losses incurred on those investments clearly show that a US recession is certain, not merely probable even as these losses occur over a period of time.

Recovery occurs as incremental asset impairment fades as does the related subtraction from normal real growth and normal growth dominates. Hiring recovers and hires back previously laid off staff plus new population labor force entrants and a recovery is sparked which for a time may cause real growth in excess of average real growth due to pent up demand, labor force and thus consumption gains, resumption of delayed capital spending to conserve corporate cash flow and mitigate declining earnings, and so on.

Productivity growth may be viewed as a step function of additional new assets, including skills, which raise productivity. Each new asset is valued according to its real productivity increase resulting in a new real constant cash flow to the owner. Thus, economic real output may be described as the sum of individual additional real assets introduced which each generate an incremental real cash flow. According to the formula for a perpetuity, the price of such an asset remains constant if its real cash flow after tax remains constant.

Extended applications exist in portfolio management, risk management, trading, arbitrage and derivatives pricing such as options and futures. Methods and systems for asset valuation, portfolio construction, analysis and asset allocation, and risk assessment are provided; driven by a Required Yield valuation/price determination engine and its derivatives fed by economic data and expectations. The invention provides a mapping of return scenarios to assets and financial products, such as mutual funds or derivatives based upon economic assumptions and the composition or structure of financial products.

### 7. Integrated Asset Analysis System

FIG. 13 is a block diagram providing an overview of an asset analysis system 10, in accordance with embodiments of the present invention. The system 10 comprises economic data 11, asset data 12, RYM input data 13, and a RYM engine 15. The economic data 11, asset data 12, and RYM input data 13 serve as input to the RYM engine 15. The economic data 11 includes data (e.g., GDP, GDP/capita growth, tax rates, inflation rate estimates/expectation, required yield, earnings estimates/expectation, interest rates, etc.) pertinent to an economy utilized by the RYM. The economic data 11 may be stored in a database or supplied as input directly to the RYM engine 15. The economic data 11 may include historic economic data as well as published economic expectations and may be obtained from any available source (e.g., any source(s) identified supra). The asset data 12 includes data (e.g., asset price, earnings data, dividends data, etc.) pertinent to asset classes (e.g., stocks, gold, bonds, etc.) being analyzed by the RYM and may be client specific. The asset data 12 may be stored in a database or supplied as input directly to the RYM engine 15. The asset data 12 may include real-time data as well as published financial expectations and may be obtained from any available source (e.g., any source(s) identified supra). The RYM input data 13 (if present) may include data specifying what functionality the RYM engine 15 is to perform (e.g., exchange rate determination, gold evaluation, bond yield curve determination, stock and stock index valuation, economic growth and earnings impairment forecasting, etc.).

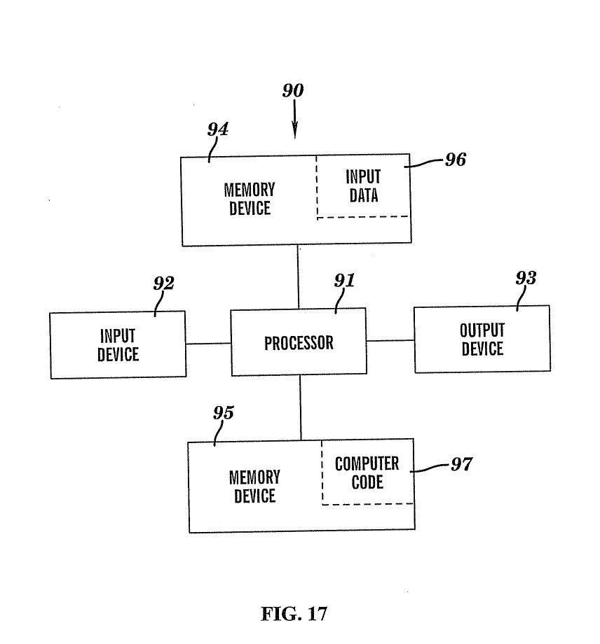

The RYM engine 15 processes the economic data 11 and asset data 12 in accordance with the RYM input data 13 (if present), by utilizing the RYM as described supra to compute the RYM output 17. The RYM engine 15 may compute and output any parameter by any mathematical formula, algorithm, or technique described supra or as described and indicated infra. For example, the RYM engine 15 may use the RYM to calculate, inter alia, one or more asset characteristics (e.g., exchange rate determination, gold evaluation, bond yield curve determination, stock and stock index valuation, economic growth and earnings impairment forecasting, etc.), utilizing the economic data 11 or utilizing both the economic data 11 and the asset data 12, as will be described infra. Whether an asset parameter is comprised by asset data 12 or is instead an asset characteristic computed by the RYM engine 15 may depend on implementation considerations. The RYM engine 15 may be implemented by software code that is executed on a computer system such as the computer system 90 described infra in conjunction with FIG. 17. The calculations and analyses performed by the RYM engine 15 may be organized into software modules or may exist in a single computer program.

The system 10 may further comprise portfolio data 16 and portfolio input 18, and an application engine 20. The portfolio data 16, portfolio input 18, and RYM output 17 (via path 24), serve as input to the application engine 20. The RYM output 17 may be transferred from the RYM engine 15 to a tangible medium such as, inter alia, an information viewing medium such as a computer screen, a printing device, a data storage medium, a database comprised by a data storage medium, etc. If transferred to a an information viewing medium or printing device, the RYM output 17 may be printed as a numerical value or may be plotted graphically.

The portfolio data 16 include data (e.g., dollars invested in various assets and asset classes) pertinent to a client portfolio being managed in conjunction with the RYM. The portfolio input 18 may include data specifying what functionality the application engine 20 is to perform. The application engine 20 processes the portfolio data 16 and the RYM output 17 in accordance with the portfolio input 18 (if present) to perform at least one function (e.g., asset valuation, asset management, trading and support, portfolio management, portfolio analysis, portfolio construction, asset allocation, risk assessment and/or management, recommendation for investment and/or trading, client account support and management, hedging, formulation of investment objectives, etc.) and generate application output 22. The application output 22 may include, inter alia, reports relating to the least one function performed by the application engine 20. Note that the at least one function may comprise at least one service performed by a service provider for a customer of the service provider.

The application engine 20 may input a request via path 25 to the RYM engine 15 to have the RYM engine 15 perform a requested calculation. The application engine 20 may be computer software code that is executed on a computer system such as the computer system 90, described infra in conjunction with FIG. 17. The functions implemented by application engine 20 may each be implemented within a distinct software module, or alternatively groups of functions implemented by the application engine 20 may each be implemented within a distinct software module, or alternatively all functions implemented by the application engine 20 may be implemented within a single software module or a single computer program.

The RYM engine 15 and the application engine 20 may be integrated within a single computer program or may separately exist within multiple computer programs. Any mathematical formula, algorithm, or technique described supra or as described and indicated infra) may be utilized by the RYM engine 15, by the application engine 20, or by both of the RYM engine 15 and the application engine 20.

### 8. Portfolio Analysis

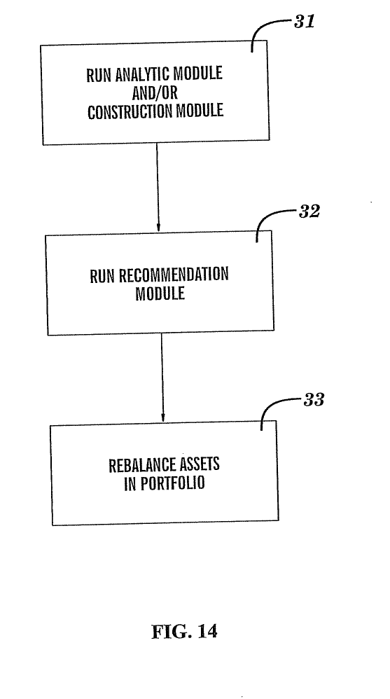

One embodiment of the present invention may include at least three manifestations: an analytic module, a construction module, and a recommendation module. Accordingly, FIG. 14 is a flow chart showing how the analytic module, construction module, and recommendation module may be utilized in accordance with the RYM to analyze a portfolio and rebalance assets therein based on said portfolio analysis, in accordance with embodiments of the present invention. The flow chart of FIG. 14 comprises steps 31-33.

Step 31 runs the analytic module and/or construction module. Using the RYM, the analytic module assesses a portfolio's assets with respect to valuation impact under various actual, historic, expected, real-time or hypothetical scenarios that may affect the RY. For example, a scenario for an increase in the RY may be run against a portfolio comprised of gold mining stocks, stocks, and bonds in one or more countries. Using the RYM, the portfolio construction module may operate upon a target return, risk, or economic scenario, yielding a series of possible asset class mixes consistent with return goals, economic expectations and risk.

Using the RYM, step 32 runs the recommendation module using the results from running the analytic module and/or construction module in step 31, as applied to an actual portfolio or one to be constructed given actual asset holdings, expected economic scenarios or desired return targets. Running the recommendations module results in suggested asset changes (e.g., sales or purchases in certain proportions of specific securities and combinations of securities) according to provided objectives or scenarios.

Based on the suggested asset changes generated by the recommendation module in step 32, in conjunction with investor industry, return, hedge and other preferences, step 33 may rebalance the assets in the portfolio to accomplish desired portfolio goals.

The Portfolio Analysis, Recommendation and Construction Modules of the present subsection may be performed in the applications 20 (see FIG. 13).

### 9. Risk Assessment and Management

Risk is traditionally defined as a probability of an adverse asset value change. In a portfolio context, aggregate risk exposure may be determined by summing the discrete risks of each asset in the portfolio in dollar or percent to total portfolio terms, with a probability assignment. Such risk assessment is often based on historic asset correlations to each other and economic conditions and factors such as interest rates; or on Monte Carlo simulations. For example, a Value at Risk (VAR, Riskmetrics®) analysis can also be undertaken by breaking-up the asset risk into its RYM based components.

The RYM enables a new means of asset and portfolio risk assessment based on the RY-driven expected value change in individual assets and asset classes; replacing or supplementing statistical measures of asset price variability or correlation as noted.

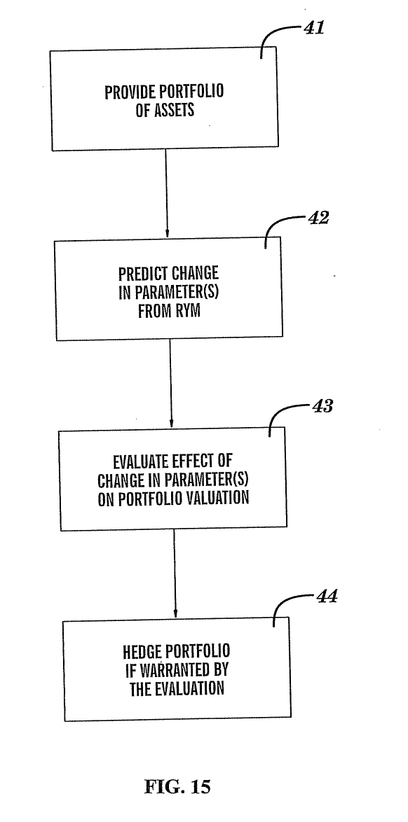

Accordingly, FIG. 15 is a flow chart in which steps 41-44 show how the RYM may be utilized to perform risk assessment and management, in accordance with embodiments of the present invention. In step 41, a portfolio of assets is provided. Step 42 predicts change in at least one asset characteristic relating to the portfolio assets, said predicted change being derived from the RYM. In the preceding example, the parameter of bond yield was predicted from the RYM to change from 4% to 4.5% for the portfolio. Step 43 evaluates effects of said predicted change to the portfolio valuation effects. In the preceding example, the portfolio valuation was predicted to decline due to the predicted bond yield increase. If the evaluation of step 43 indicates an unacceptable risk, it may be desirable to hedge the portfolio in step 44, as described infra.

Another aspect of risk assessment relates to calculating the volatility of any asset characteristic that is within the framework of the RYM. The volatility of the asset characteristic may as expressed as a standard deviation (or as another measure of dispersion) of the asset characteristic.

The risk assessment and management of the present subsection may be performed in the applications 20 (see FIG. 13).

Based on the degree to which a current market value departs from the value computed according to the present invention, a risk assessment can be provided of the likelihood of a contrary market movement. This risk assessment may be used to quantify the type and amount of hedging instruments to employ for any given portfolio or scenario. Similarly, a future market value predicted by the RYM based upon user inputs of economic variables or market consensus expectations, may enable a hedge of a current asset position. Derivatives may be employed in hedging or asset classes with expected counter-balancing price functions may be added to a portfolio.

For example, a stock index expected revaluation of a 10% price decline may be hedged by purchasing put options with an expected equal gain in value to the expected loss in the aggregate S&P 500 portfolio value. The RYM enables precise valuation of assets under changing possible RY conditions, thus enabling offsetting hedging strategies.

Accordingly, the hedging step 44 of FIG. 14 may be performed if warranted by the evaluated effects of parameter change(s) in step 43 of FIG. 14.

The hedging may be performed in the applications 20 (see FIG. 13).

### 10. Technical and Sentiment Analysis

Technical analysis may be defined as the use of visual patterns or the mathematical or digital depictions of such patterns that are associated with subsequent or contemporaneous price and/or volume movements of assets. All known technical indicators may be utilized (e.g., moving averages, momentum indicators, oscillators, relative strength index, price patterns, volume accumulation, etc.). Sentiment relates to investor sentiment (i.e., bullish, bearish, or neutral). All known sentiment indicators may be utilized (e.g., put/call ratio, short sale ratio, etc.)

In one embodiment, RY valuation techniques based on the RYM may be utilized in conjunction with technical analysis and/or sentiment analysis to validate a conclusion and/or investment action. For example with respect to technical analysis, if successive new stock price highs are accompanied by increasing market breadth and increasing new highs vs. new lows, and the market is below the RY value, buying stocks may be considered desirable. For example with respect to sentiment analysis, if the put/sell ratio (which is a contrarian indicator) of an option is significantly higher than its normal range of values, then a highly bearish sentiment exists for the underlying stock which (from a contrarian point of view) may imply that a purchase of the underlying stock is desirable if the market is below the RY value.

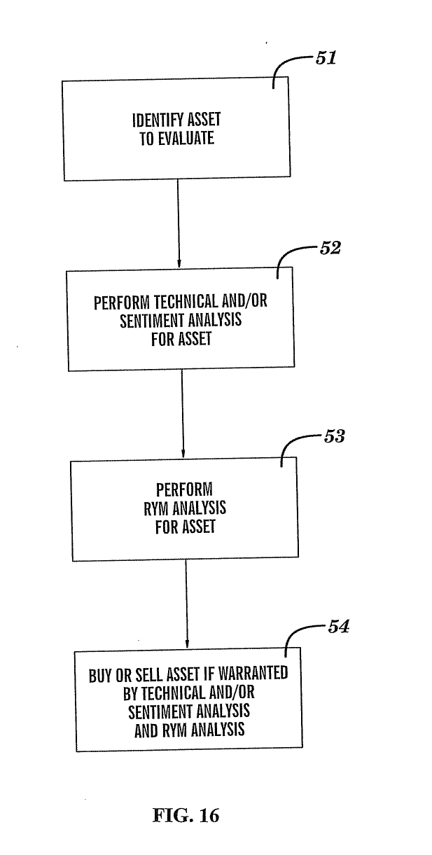

Accordingly, FIG. 16 is a flow chart in which steps 51-54 show how technical analysis and/or sentiment analysis may be utilized in conjunction with the RYM to determine whether to buy or sell an asset, in accordance with embodiments of the present invention. In step 51 an asset to be evaluated is identified. Step 52 performs technical analysis and/or sentiment analysis for the asset to determine whether a market movement is predicted for the asset. Step 53 performs a RYM analysis to determine whether the asset is overvalued or undervalued. Step 54 reviews the results of steps 52 and 53 to determine whether the results of steps 52 and 53 are consistent with each other. If step 52 predicts that an upward movement in asset price may occur and if step 53 determines that the asset is undervalued, then steps 52 and 53 are consistent in that both steps 52 and 53 are suggesting that it may be desirable to buy the asset. If step 52 predicts that a downward movement in asset price may occur and if step 53 determines that the asset is overvalued, then steps 52 and 53 are consistent in that both steps 52 and 53 are suggesting that it may be desirable to sell the asset. Thus step 54 may result in buying or selling the asset based if warranted by the collective results of steps 52 and 53.

The use of the RYM in conjunction with Technical Analysis and/or Sentiment Analysis of the present subsection may be performed by the RYM engine 15, by the applications 20, or by both (see FIG. 13).

### 11. Computer System

FIG. 17 illustrates a computer system 90 used for performing an asset analysis according to the Required Yield Method (RYM), in accordance with embodiments of the present invention. The computer system 90 comprises comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes an algorithm for performing an asset analysis according to the Required Yield Method (RYM). The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 17) may be used as a computer readable storage medium (or a program storage device) having a computer readable program code embodied therein and/or having other data stored therein, wherein the computer readable program code comprises the computer code 97.

Generally, a computer program product (or, alternatively, an article of manufacture) of the computer system 90 may comprise said computer readable storage medium (or said program storage device). The computer program product tangibly embodies readable program means for causing the computer system 90 to perform the methods of the present invention. Thus, the computer program product comprises a storage medium having computer readable program code (i.e., the readable program means) stored therein, said program code configured to be executed by the computer system 90 to cause the computer system 90 to perform the methods of the present invention.

The present invention discloses a process for deploying or integrating computing infrastructure, comprising integrating computer-readable code into the computer system 90, wherein the code in combination with the computer system 90 is capable of performing a method for performing an asset analysis according to the Required Yield Method (RYM).

While FIG. 17 shows the computer system 90 as a particular configuration of hardware and software, any configuration of hardware and software, as would be known to a person of ordinary skill in the art, may be utilized for the purposes stated supra in conjunction with the particular computer system 90 of FIG. 17. For example, the memory devices 94 and 95 may be portions of a single memory device rather than separate memory devices.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method for performing an asset analysis, said method comprising:
computing, by a processor of a computer system, at least one asset characteristic of at least one asset or of a plurality of asset classes, said at least one asset characteristic selected from the group consisting of a first asset characteristic, a second asset characteristic, a third asset characteristic, a fourth asset characteristic, a fifth asset characteristic, a sixth asset characteristic, a seventh asset characteristic, an eighth asset characteristic, a ninth asset characteristic, a tenth asset characteristic, and combinations thereof;
transferring the computed at least one asset characteristic to a tangible medium selected from the group consisting of an information viewing medium, a printing device, a data storage medium, and combinations thereof;
utilizing one or more computed asset characteristics of the computed least one asset characteristic, said utilizing comprising performing at least one function selected from the group consisting of asset valuation, asset management, trading, portfolio management, portfolio analysis, portfolio construction, asset allocation, risk assessment and/or management, making a recommendation for investment and/or trading, client account support and management, hedging, formulation of investment objectives, running an analytic module comprising assessing a portfolio having the at least one asset therein, running a construction module comprising performing at least one risk and/or economic scenario and generating results therefrom, and combinations thereof;
wherein the first asset characteristic comprises a new or expected currency exchange rate between a first country (C₁) and a second country (C₂) at time t₁, said computing the at least one asset characteristic comprising computing the new or expected currency exchange rate at time t₁ as a function of C₁^{g+1} and C₂^{g+1}, said C₁^{g+1} being an expected real gross domestic product (GDP) growth rate per capita of the first country for a next time period from time t₀ to time t₁ such that t₀<t₁, said C₂^{g+1} being an expected real GDP growth rate per capita of the second country for the next time period;
wherein the second asset characteristic comprises a world gold price at time t₁, said computing the at least one asset characteristic comprising computing the world gold price at time t₁ as a function of (P_{w}⁺¹/S⁺¹) and (P_{w}⁰/S⁰), said P_{w}⁺¹ being an expected world real GDP at time t₁, said S⁺¹ being an expected total world above ground gold stock at time t₁, said P_{w}⁰ being a world real GDP at time t₀ such that t₀<t₁, said S⁰ being an above ground world gold stock at time t₀;
wherein the third asset characteristic comprises a national gold price of a country at time t₁, said computing the at least one asset characteristic comprising computing the national gold price at time t₁ as a function of W_{g} and C_{g}, said W_{g} being a world expected real per capita GDP growth rate for a next time period from time t₀ to time t₁ such that t₀<t₁, said C_{g} being an expected real per capita GDP growth rate of the country for the next time period;
wherein the fourth asset characteristic comprises an expected or next period earnings per share (EPS) of a stock index with respect to an economy, said computing the at least one asset characteristic comprising computing the expected or next period EPS of the stock index as a function of Y⁺¹/Y⁰, said Y⁰ being a required yield of the economy for a current time period such that the current period precedes a next time period, said Y⁺¹ being a required yield of the economy for the next time period;
wherein the fifth asset characteristic comprises a current price of a stock index or stock with respect to an economy, said computing the at least one asset characteristic comprising computing the current price of the stock index or stock as a function of a weighted difference between the EPS of the stock index or stock in successive periods of time, the EPS in each period exceeding an expected GDP per capita growth rate in each period;
wherein the sixth asset characteristic comprises a consol-type yield of a consol-type instrument traded within a world or national economy characterized by a commodity standard in which a value of the world or national currency depends on a fixed exchange rate between money and gold, said computing the at least one asset characteristic comprising computing the consol-type yield as a function of (Z_{g}⁺¹/G_{w}⁺¹) and (Z_{g}⁰/G_{w}⁰), said Z_{g}⁺¹ being an expected total above ground world gold stock at time t₁, said Z_{g}⁰ being a total above ground world gold stock at time t₀ such that t₀<t₁, said G_{w}⁺¹ being an expected world or national economy real GDP for time t₁, said G_{w}⁰ being a world or national economy real GDP at time t₀;
wherein the seventh asset characteristic comprises a yield spread between a long and short term Treasury bond with respect to an economy, said computing the at least one asset characteristic comprising computing the yield spread as a function of R_{L} and R_{S}, said R_{L} being an expected long term real after-tax return on stock market equity subject to R_{L} not exceeding Y_{P}, said R_{S} being an expected short term real after-tax return on stock market equity subject to R_{L} not exceeding Y_{P}, said Y_{P} being a constant after-tax required yield of a financial asset anchored on a GDP productivity growth rate per capita for the economy;
wherein the eighth asset characteristic comprises a dividend yield (D_{Y}) of a stock index or stock with respect to an economy, said computing the at least one asset characteristic comprising computing D_{Y} via D_{y}=Y−E₁, said Y being an after-tax required yield for the economy, said E₁ being an expected long term growth rate of the EPS of the stock index or stock, said E₁ being less than (g+i), said g being an expected GDP growth rate per capita for the economy, said i being an expected inflation rate for the economy;
wherein the ninth asset characteristic comprises a bond price of a bond at a time t₀, said bond having n remaining consecutive coupon payment periods of time from time t₀ such that a designated coupon amount is required to be paid to a holder of the bond at an end of each remaining coupon payment period, said computing the at least one asset characteristic comprising computing the bond price as a function of i₁, i₂, . . . , iₙ, said iₘ (m=1, 2, . . . , n) being an interest rate/yield of a similarly rated/callable bond having a maturity of m coupon payment periods from time t₀; and
wherein the tenth asset characteristic comprises an expected GDP of an economy, said computing the at least one asset characteristic comprising computing the expected GDP of the economy for a specified time period as a function of a sum of changes over the time period in an expected value of each asset class of a plurality of asset classes with respect to the assets in each asset class.

2. The method of claim 1, wherein the at least one asset characteristic comprises the first asset characteristic, the second asset characteristic, the third asset characteristic, the fourth asset characteristic, the fifth asset characteristic, or combinations thereof.

3. The method of claim 2, wherein the at least one asset characteristic comprises the first asset characteristic, the second asset characteristic, the third asset characteristic, or combinations thereof.

4. The method of claim 3, wherein the at least one asset characteristic comprises the first asset characteristic.

5. The method of claim 3, wherein the at least one asset characteristic comprises the second asset characteristic.

6. The method of claim 3, wherein the at least one asset characteristic comprises the third asset characteristic.

7. The method of claim 2, wherein the at least one asset characteristic comprises the fourth asset characteristic, the fifth asset characteristic, or a combination thereof.

8. The method of claim 7, wherein the at least one asset characteristic comprises the fourth asset characteristic.

9. The method of claim 7, wherein the at least one asset characteristic comprises the fifth asset characteristic.

10. The method of claim 1, wherein the at least one asset characteristic comprises the sixth asset characteristic, the seventh asset characteristic, the eighth asset characteristic, the ninth asset characteristic, the tenth asset characteristic, or combinations thereof.

11. The method of claim 10, wherein the at least one asset characteristic comprises the sixth asset characteristic, the seventh asset characteristic, the eighth asset characteristic or combinations thereof

12. The method of claim 11, wherein the at least one asset characteristic comprises the sixth asset characteristic.

13. The method of claim 11, wherein the at least one asset characteristic comprises the seventh asset characteristic.

14. The method of claim 11, wherein the at least one asset characteristic comprises the eighth asset characteristic.

15. The method of claim 10, wherein the at least one asset characteristic comprises the ninth asset characteristic, the tenth asset characteristic, or a combination thereof.

16. The method of claim 15, wherein the at least one asset characteristic comprises the ninth asset characteristic.

17. The method of claim 15, wherein the at least one asset characteristic comprises the tenth asset characteristic.

18. A computer system, comprising a processing unit and a computer readable memory unit coupled to the processing unit, said memory unit containing instructions configured to be executed by the processing unit to implement the method of claim 1, said processing unit being said processor.

19. A computer program product, comprising a computer readable storage medium having a computer readable program code stored therein, said computer readable program code containing instructions configured to be executed by a processing unit to implement the method of claim 1 said processing unit being said processor.
